(19) United States
(12) Patent Application Publication
(10) Pub. No.: US 2025/0227613 A1
(43) Pub. Date: Jul. 10, 2025

(54) POWER EFFICIENT AND ROBUST WAKE UP SIGNALING - GROUP WAKE-UP

(71) Applicant: Telefonaktiebolaget LM Ericsson (publ), Stockholm (SE)

(72) Inventors: Saeed Bastani, Dalby (SE); Bipin Balakrishnan, Kävlinge (SE); Gang Zou, Lund (SE); Fredrik Dahlgren, Lund (SE)

(21) Appl. No.: 18/849,516

(22) PCT Filed: Mar. 23, 2022
(86) PCT No.: PCT/EP2022/057679

§ 371 Date: Sep. 22, 2024

(51) Int. Cl. H04W 52/02; H04L 5/00; H04W 56/00

(52) U.S. Cl. CPC H04W 52/0219; H04L 5/0053; H04W 52/0235; H04W 56/0015

(57) ABSTRACT

Systems and methods are disclosed for relayed group wake-up of a group of remote User Equipments (UEs) in a wireless communication system. In one embodiment, a method performed by a relay UE for group wake-up of a group of remote UEs comprises receiving a group wake-up signal (WUS) from another radio node and performing a group wake-up procedure for a group of remote UEs that are in an idle state, the group of remote UEs comprising one or more remote UEs. In this manner, the efficiency of wake-up procedure is improved by minimizing the signaling overhead via simultaneous wake-up signaling to a group of UEs.

### TECHNICAL FIELD

Systems and methods are disclosed herein that relate to wake-up signaling in a wireless communication system.

### BACKGROUND

Relay-connections using sidelink or Device-to-Device (D2D) communication has been presented in order to increase the wireless communication coverage in situations where the Radio Frequency (RF) link between a Base Station (BS) and a User Equipment (UE) may be very poor or totally lost. For example, see Third Generation Partnership Project (3GPP) Long Term Evolution (LTE) D2D Proximity Services (ProSe) and an associated study in 3GPP Technical Report (TR) 36.843 entitled “Study on LTE Device to Device Proximity Services-Radio Aspects.”

On the other hand, wake-up signaling has been proposed to enable UEs to go into deep sleep and the BS to wake up the UEs with certain signaling. For example, the 3GPP LTE cellular network uses a Wake-Up Signal (WUS) to wake up Internet-of-Things (IoT) UEs. This WUS is transmitted from a BS to IoT UEs that are in idle mode (e.g., deep sleep) and required to decode the Physical Downlink Control Channel (PDCCH) in paging occasions (see, e.g., 3GPP Technical Specification (TS) 36.211 V16.1.0). In those cases, an IoT UE needs wake up to perform time and frequency synchronization, receive and decode the WUS, and further receive and decode the paging information carried in a PDCCH if the IoT finds the WUS is targeting itself. As the distance between the BS and the IoT UE is generally long, the WUS is often transmitted with a certain RF bandwidth and/or encoded in time or frequency domain to lower its miss-detection rate. Ultra-low-power UEs (e.g., IoT UEs) may be powered from a battery with very limited capacity or from energy harvested from the environment in which the UEs are located. It is important that the amount of energy consumed by these UEs for communication is kept as low as possible. Allowing these UEs to go into a deep-sleep mode (e.g., idle mode) when there is no need to communicate is one technique for minimizing energy consumption. Another technique is to minimize the amount of energy consumed while the UE is performing necessary communication such as by keeping the UE's transmit power (e.g., Uplink (UL) transmit power) as low as possible.

There are many relevant usages of ultra-low-power UEs as different types of sensors, etc. They can be deployed in an environment in which the UEs have very poor RF links to the BSs, such as in basements, behind walls, etc. This can make it very challenging to guarantee that the UE is woken up properly by the BS and also require that the UL signaling from the UE at the wake-up must occur at a very high transmit power. Furthermore, wake-up mechanisms for such ultra-low power UEs should be robust and reliable against misdetection without consuming too much additional power.

Therefore, there is a need for systems and methods providing an energy efficient yet robust solution to wake up UEs, such as ultra-low power UEs, and transfer data between those UEs and the BS.

### SUMMARY

Systems and methods are disclosed for relayed group wake-up of a group of remote User Equipments (UEs) in a wireless communication system. In one embodiment, a method performed by a relay UE for group wake-up of a group of remote UEs comprises receiving a group wake-up signal (WUS) from another radio node and performing a group wake-up procedure for a group of remote UEs that are in an idle state, the group of remote UEs comprising one or more remote UEs. In this manner, the efficiency of wake-up procedure is improved by minimizing the signaling overhead via simultaneous wake-up signaling to a group of UEs.

In another embodiment, performing the group wake-up procedure comprises detecting the group WUS received from another radio node, decoding the group WUS to determine the one or more remote UEs in the group of remote UEs, and generating and transmitting a WUS to each of the one or more remote UEs in the group.

In another embodiment, performing the group wake-up procedure comprises monitoring for wake-up acknowledgements from the one or more remote UEs, determining whether wake-up acknowledgements are detected from all of the one or more remote UEs while monitoring for the wake-up acknowledgements. Performing the group wake-up procedure further comprises, responsive to determining that wake-up acknowledgements have not been detected for all of the one or more remote UEs, identifying one or more remote UEs in the group for which a wake-up acknowledgement has not been detected and transmitting a wake-up signal to the one or more remote UEs in the group for which a wake-up acknowledgement has not been detected. In one embodiment, performing the group wake-up procedure further comprises setting one or more timers, wherein monitoring for wake-up acknowledgements from the one or more remote UEs comprises monitoring for wake-up acknowledgements from the one or more remote UEs while the one or more timers are running. In one embodiment, the method further comprises repeating the steps of monitoring, determining, identifying, and transmitting until either wake-up acknowledgements have been detected for all of the one or more remote UEs in the group or a maximum number of wake-up attempts has been reached. In one embodiment, generating and transmitting the WUS to each of the one or more remote UEs in the group comprises generating and transmitting a LPWUS to each of the one or more remote UEs in the group. In one embodiment, the LPWUS has one or more characteristics that enable a power cost for detecting the LPWUS to be less than a power cost for detecting a WUS from a base station. In one embodiment, the method further comprises generating and transmitting a synchronization signal for the one or more remote UEs in the group. In one embodiment, generating and transmitting the synchronization signal for the one or more remote UEs in the group comprises broadcasting the synchronization signal for the one or more remote UEs in the group. In another embodiment, generating and transmitting the synchronization signal for the one or more remote UEs in the group comprises generating and transmitting a separate synchronization signal to each of the one or more remote UEs in the group.

In one embodiment, performing the group wake-up procedure comprises detecting the group WUS received from another radio node, decoding the group WUS to determine the one or more remote UEs in the group of remote UEs, monitoring for wake-up acknowledgements from the one or more remote UEs, and determining whether wake-up acknowledgements are detected from all of the one or more remote UEs while monitoring for the wake-up acknowledgements. Performing the wake-up procedure further comprises, responsive to determining that wake-up acknowledgements have not been detected for all of the one or more remote UEs, identifying one or more remote UEs in the group for which a wake-up acknowledgement has not been detected and transmitting a wake-up signal to the one or more remote UEs in the group for which a wake-up acknowledgement has not been detected. In one embodiment, performing the group wake-up procedure further comprises setting one or more timers, wherein monitoring for wake-up acknowledgements from the one or more remote UEs comprises monitoring for wake-up acknowledgements from the one or more remote UEs while the one or more timers are running. In one embodiment, transmitting the wake-up signal to the one or more remote UEs in the group for which a wake-up acknowledgement has not been detected comprises transmitting a low-power wake-up signal (LPWUS) to each of the one or more remote UEs in the group for which a wake-up acknowledgement has not been detected. In one embodiment, the LPWUS has one or more characteristics that enable a power cost for detecting the LPWUS to be less than a power cost for detecting a WUS from a base station. In one embodiment, the method further comprises transmitting a synchronization signal for the one or more remote UEs in the group for which a wake-up acknowledgement has not been detected. In one embodiment, transmitting the synchronization signal for the one or more remote UEs in the group for which a wake-up acknowledgement has not been detected comprises broadcasting the synchronization signal for the one or more remote UEs in the group for which a wake-up acknowledgement has not been detected. In another embodiment, transmitting the synchronization signal for the one or more remote UEs in the group for which a wake-up acknowledgement has not been detected comprises transmitting a separate synchronization signal to each of the one or more remote UEs in the group for which a wake-up acknowledgement has not been detected. In one embodiment, the method further comprises repeating the steps of monitoring, determining, identifying, and transmitting until either wake-up acknowledgements have been detected for all of the one or more remote UEs in the group or a predefined or preconfigured maximum number of wake-up attempts has been reached. In one embodiment, transmit power for transmitting the wake-up signal is increased for at least one iteration of repeating the steps. In one embodiment, the predefined or preconfigured maximum number of wake-up attempts is configured by the base station.

In one embodiment, receiving the group WUS from another radio node comprises receiving the group WUS from a base station via one or more additional relay UEs.

In one embodiment, the method further comprises relaying the group WUS to one or more additional relay UEs.

Corresponding embodiments of a relay UE are also disclosed. In one embodiment, a relay UE for group wake-up of a group of remote UEs is adapted to receive a group WUS from another radio node and perform a group wake-up procedure for a group of remote UEs that are in an idle state, the group of remote UEs comprising one or more remote UEs.

In one embodiment, a relay UE for group wake-up of a group of remote UEs comprises one or more transmitters, one or more receivers, and processing circuitry associated with the one or more transmitters and the one or more receivers. The processing circuitry is configured to cause the relay UE to receive a group WUS from another radio node and perform a group wake-up procedure for a group of remote UEs that are in an idle state, the group of remote UEs comprising one or more remote UEs.

Embodiments of a method performed by a remote UE are also disclosed. In one embodiment, a method performed by a remote UE for wake-up from an idle state, comprises receiving a WUS from a first relay UE for group wake-up of a first group of remote UEs in which the remote UE is included and refraining from responding to a WUS from any other relay UE for group wake-up of another group of remote UEs in which the remote UE is also included while performing wake-up responsive to receiving the WUS from the first relay UE.

In one embodiment, the method further comprises, after wake-up, receiving a WUS from a second relay UE for group wake-up of a second group of remote UEs in which the remote UE is included and responding to the second relay UE. In one embodiment, responding to the second relay UE comprises sending a negative acknowledgement to the second relay UE. In another embodiment, responding to the second relay UE comprises sending a positive acknowledgement to the second relay UE. Corresponding embodiments of a remote UE are also disclosed. In one embodiment, a remote UE for wake-up from an idle state is adapted to receive a WUS from a first relay UE for group wake-up of a first group of remote UEs in which the remote UE is included and refrain from responding to a WUS from any other relay UE for group wake-up of another group of remote UEs in which the remote UE is also included while performing wake-up responsive to receiving the WUS from the first relay UE.

In one embodiment, a remote UE for wake-up from an idle state comprises one or more transmitters, one or more receivers, and processing circuitry associated with the one or more transmitters and the one or more receivers. The processing circuitry is configured to cause the remote UE to receive a WUS from a first relay UE for group wake-up of a first group of remote UEs in which the remote UE is included and refrain from responding to a WUS from any other relay UE for group wake-up of another group of remote UEs in which the remote UE is also included while performing wake-up responsive to receiving the WUS from the first relay UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a system in which embodiments of the present disclosure may be implemented;

FIG. 2 is a flow chart that illustrates the operation of a base station, a relay User Equipment (UE), and a remote UE for Low Power Wake-Up (LPWUS) signaling in accordance with one embodiment of the present disclosure;

FIGS. 3A, 3B, 4A, and 4B illustrate example subframes in which a synchronization signal and a LPWUS are transmitted in accordance with example embodiments of the present disclosure;

FIG. 5 illustrates the operation of a base station, a relay UE, and a remote UE in accordance with at least some of the embodiments described herein;

FIG. 6 illustrates a system in which relayed group wake-up signaling may be used in accordance with one example embodiment of the present disclosure;

FIG. 7 is a flow chart that illustrates the operation of a base station to perform a grouping procedure in accordance with one example embodiment of the present disclosure;

FIG. 8 illustrates the operation of a base station, a relay UE, and a group of remote UEs for relayed group wake-up in accordance with one example embodiment of the present disclosure;

FIG. 9 is a flow chart that illustrates steps 804 and 806 of FIG. 8 in more detail, in accordance with one example embodiment of the present disclosure;

FIG. 10 is a flow chart that illustrates steps 804 and 806 of FIG. 8 in more detail, in accordance with another example embodiment of the present disclosure;

FIG. 11 illustrates one example of a system in which hierarchical wake-up is provided in accordance with an embodiment of the present disclosure;

FIG. 12 illustrates one example of a system that provides relayed group wake-up with overlapping groups in accordance with an embodiment of the present disclosure;

FIG. 13 is a flow chart that illustrates the operation of a remote UE that is simultaneously in two or more groups in accordance with one embodiment of the present disclosure;

FIG. 14 is a schematic block diagram of a radio access node according to some embodiments of the present disclosure;

FIG. 15 is a schematic block diagram that illustrates a virtualized embodiment of the radio access node of FIG. 14 according to some embodiments of the present disclosure;

FIG. 16 is a schematic block diagram of the radio access node of FIG. 14 according to some other embodiments of the present disclosure;

FIG. 17 is a schematic block diagram of a UE according to some embodiments of the present disclosure;

FIG. 18 is a schematic block diagram of the UE of FIG. 17 according to some other embodiments of the present disclosure;

FIG. 19 illustrates a telecommunication network connected via an intermediate network to a host computer in accordance with some embodiments of the present disclosure;

FIG. 20 is a generalized block diagram of a host computer communicating via a base station with a UE over a partially wireless connection in accordance with some embodiments of the present disclosure;

FIG. 21 is a flowchart illustrating a method implemented in a communication system in accordance with one embodiment of the present disclosure;

FIG. 22 is a flowchart illustrating a method implemented in a communication system in accordance with one embodiment of the present disclosure;

FIG. 23 is a flowchart illustrating a method implemented in a communication system in accordance with one embodiment of the present disclosure; and

FIG. 24 is a flowchart illustrating a method implemented in a communication system in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

User Equipment (UE): One type of communication device is a UE, which herein refers to any wireless communication device that has access to (i.e., is served by) a wireless network (e.g., a cellular network). Some examples of a wireless communication device include, but are not limited to: a 3GPP UE (i.e., a UE in a 3GPP network), a Machine Type Communication (MTC) device (also referred to herein as a MTC UE, and an Internet of Things (IoT) device (also referred to herein as an IoT UE). Such UEs may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The UE may be a portable, hand-held, computer-comprised, or vehicle-mounted mobile device, enabled to communicate voice and/or data via a wireless connection.

Relay UE: As used herein, a “relay UE” is a UE that, in addition to having communication to/from a RAN node (e.g., a base station), can also have communication to and from another UE, for example, via a D2D link or 3GPP sidelink. This other UE is referred to herein as a “remote UE”. Furthermore, a relay UE can receive and transmit data and control signals on behalf of the remote UE(s) to which it has a direct communication link. The relay UE is in proximity of one or more remote UEs.

Remote UE: As used herein, a “remote UE” is a UE that is capable of both D2D or 3GPP sidelink communication to the relay UE and direct communication to a base station. Typically, the remote UE is power constrained. The remote UE operates in a deep-sleep mode of operation (e.g., 3GPP idle mode) and can be woken up by a wake-up signal. Sometimes in the present disclosure, the term “sensor UE” or “sensor node” is used to denote a type of remote UE that is extremely power constrained.

Network Node: As used herein, a “network node” is any node that is either part of the RAN or the core network of a cellular communications network/system.

Low-Power Wake-Up Signal (LPWUS): As used herein, a “LPWUS” is a special paging signal that is transmitted from a relay UE to one or more remote UEs to inform the one or more remote UEs to wake-up from a deep-sleep state (e.g., a 3GPP idle mode). The LPWUS has one or more characteristics (e.g., narrow bandwidth and/or simplified modulation and coding scheme) that enable a power cost for detecting the LPWUS at a remote UE to be less than a power cost for detecting a conventional WUS from a base station at the remote UE. The one or more characteristics of the LPWUS enable detection at the remote UE via a low power receiver, e.g. an envelope detector, comparator, and time-domain correlator.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Various aspects of the present disclosure are described below under separate headings. While the embodiments described in each section may be used independently, embodiments described in different sections below may also be combined.

### I. Low-Power Wake-Up Signal (LPWUS) via Relay UE

As discussed above, there is a need for systems and methods providing an energy efficient yet robust solution to wake up UEs, such as ultra-low power UEs, and transfer data between those UEs and the base station. For ultra-low-power IoT devices, e.g. wireless sensors, placing relay nodes is one approach to extend cellular network coverage over them. For instance, Cheng, X., Du, DZ., Wang, L. et al. Relay sensor placement in wireless sensor networks, Wireless Network 14, 347-355 (2008) https://doi.org/10.1007/s11276-006-0724-8 (hereinafter referred to as the “Cheng Article”) proposed a solution to place relay nodes in a wireless sensor network. All the wireless sensors can be connected to the relay nodes, which are more powerful and able to transfer data over long distance. Further, in United States Patent Application Publication No. 2020/0163017 A1 (hereinafter “the '017 Application”), the use of a relay UE to transmit a wake-up signal (WUS) to a remote UE (e.g., an IoT UE) is proposed. However, besides the WUS itself, there is a need to re-establish time synchronization between the IoT UE and the network when the IoT UE wakes up from deep sleep, and this demands further signal transmission/reception. This re-establishment of time synchronization is not addressed in the '017 Application.

Systems and methods are disclosed herein that address the aforementioned and/or other problems. Embodiments of the solution disclosed herein are based on relayed wake-up of a remote UE (e.g., an IoT UE such as, e.g., a sensor) via a relay UE and subsequent data transfer between the relay UE and remote UE. The rationale is that the distance between the relay UE (e.g., selected based on coverage) and the remote UE is much shorter than the distance between base station and the remote UE making such a system more robust and leading to lower power consumption in the remote UE.

By introducing a relay UE, embodiments of the solution disclosed herein enable ultra-low-power UEs to enter/exit deep sleep without having to communicate directly with the base station.

Whereas the basic idea of using a relay node to transmit a wake-up signal to an IoT UE is described in the '017 Application, there are multiple aspects of the embodiments disclosed herein, which are potentially independent, that all support a much more energy efficient and robust system:
A first aspect relates to mechanisms and procedures for re-establishing time and frequency synchronization of the remote UEs after deep sleep by the support of the relay UE. In this regard, two time/frequency re-synchronization schemes (denoted herein as “TRS1” and “TRS2”) to achieve various synchronization accuracy by a remote UE with the support of the relay UE are disclosed herein.
A second aspect relates to co-design of time and frequency (time/frequency) synchronization signals and a Low-Power Wake-Up Signal (LPWUS) transmitted by a relay UE so that the remote UE can be more power efficient when performing time/frequency synchronization and LPWUS detection.
A third aspect relates to optimizations in the signaling between the relay UE and the remote UE that, because of much shorter distances, are able to minimize power consumption at the remote UE. These optimizations may include, e.g., optimizations to a time offset between the synchronization signal and the LPWUS, optimizations to a bandwidth of the LPWUS and/or the synchronization signal, optimizations related to the type of modulation and coding used for the LPWUS (e.g., can be dynamically adapted to be more/less robust based on the distance between the relay UE and the remote UE), optimizations related to transmit power, etc.

Embodiments of the solutions disclosed herein may enable better coverage for UEs that are in deep sleep (i.e., low power) mode, may enable lower uplink transmit power from remote UEs (e.g., IoT UEs) for wake-up sequences and communication, and/or may allow for a simpler and lower power wake-up receiver mode within remote UEs.

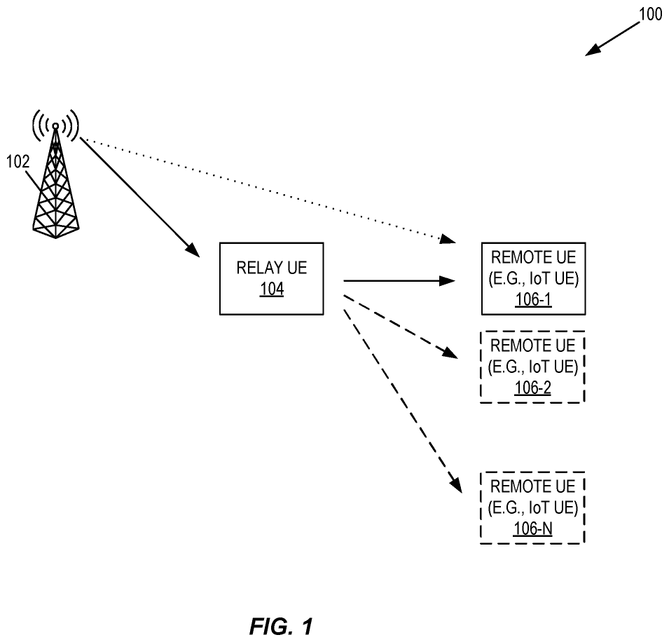

In this regard, FIG. 1 illustrates a system 100 in which embodiments of the present disclosure may be implemented. As illustrated, the system 100 includes a base station 102 and a relay UE 104 that operates as proxy between the base station 102 and one or more remote UEs 106-1 to 106-N, which are generally referred to herein collectively as remote UEs 106 and individually as a remote UE 106. The remote UEs 106 may be, for example ultra-low power IoT UEs. The remote UEs 106 operate in a deep sleep mode of operation (e.g., an idle mode) until woken up by a WUS or Low-Power WUS (LPWUS). In addition, the remote UEs 106 could be in a non-coverage region (i.e., they may have very poor Radio Frequency (RF) link to the base station 102 such that no or limited radio signal from the base station 102 can be received by the remote UEs 106 in the non-coverage region). A non-coverage region may also be referred to as a shadow region.

The base station 102 is aware, e.g., due to the authentication procedures, of remote UEs 106 in an area. The base station 102 can further identify a UE (or multiple UEs) in the vicinity of the remote UEs 106 as the relay UE 104 for these remote UEs 106. For example, the base station 102 may estimate the locations of the UEs under its coverage and select UEs close to the remote UEs 106 as relay candidates. Furthermore, based on received measurement reports from UEs, the base station 102 builds an understanding of coverage/signal strength, transmit power of UEs, mobility of the UEs, etc. and then determines both the remote UEs 106 and the relay UE 104 for those remote UEs 106. Thereafter, the base station 102 notifies both the relay UE 104 and the remote UEs 106 of the pairing. For example, the base station 102 may share UE IDs of the remote UEs 106 with the relay UE 104 and/or inform the remote UEs 106 of a relay ID of the relay UE 104. Once a pairing acknowledgement is received by the base station 102 from each individual remote UE 106 directly (or in some embodiments via the relay UE 104 on behalf of the individual remote UEs 106), the base station 102 notifies the remote UEs 106 directly (or in some embodiments via the relay UE 104), that they can go into a deep sleep mode and, upon reception of a wake-up signal, need to communicate with the relay UE 104 or communicate directly with the base station 102.

When the base station 102 desires to wake-up and fetch data from a remote UE 106 (or a group of remote UEs 106), the base station 102 transmits a WUS which includes identifier (ID) of that remote UE 106 (or that group of remote UEs 106). As described below in detail, the relay UE 104 operates to receive and decode the WUS on behalf of the remote UE 106 (or group of remote UEs 106). The relay UE 104 then generates and transmits a LPWUS so that the remote UE 106 (or group of remote UEs 106) for which the WUS from the base station 102 is intended is (are) woken-up. In one embodiment, the LPWUS is encoded with the ID of the remote UE 106 (or the ID of the group of remote UE(s)) to be woken-up.

As the distance between the relay UE 104 and the remote UEs 106 is much shorter than the distance between base station 102 and the remote UEs 106, the LPWUS transmitted from the relay UE 104 to the remote UEs 106 can be much simplified, as compared to the WUS transmitted by the base station 102, by using a simple radio waveform (for example, by being coded with On-Off Keying (OOK)) so that the power cost to detect the LPWUS by the remote UEs 106 can be much less than that to detect the WUS from the base station 102. For example, an Orthogonal Frequency Division Multiplexing (OFDM) transmitter can be used to generate the LPWUS as an OOK pulse. One example of a OOK wakeup signal and corresponding low-power receiver is described in J. Moody et al., “A-76 dBm 7.4nW Wakeup Radio With Automatic Offset Compensation”, ISSCC 2018. Upon detecting the LPWUS, the remote UE 106 sends a LPWUS acknowledgement (ACK) only to the relay node 104 and not to the base station 102 which initiated the wake up signaling, which enables reducing the RF transmission power of the LPWUS ACK as compared to that which would be needed to transmit a WUS ACK to the base station 102.

In addition to the LPWUS, embodiments are disclosed herein to establish time and frequency re-synchronization for the remote UEs 106 in association with LPWUS detection. Embodiments disclosed herein optimize the time/frequency synchronization together with LPWUS detection for the sake of UE power saving.

Embodiments of the present disclosure consider one or more of the following aspects for the relay UE 104 to configure the synchronization signals together with the LPWUS:
waveform and bandwidth of the synchronization signals, e.g. OFDM multiple carrier signal or single carrier signal can be exploited as the synchronization signals,
coding scheme of the synchronization signals, e.g. the ID of the relay UE 104 can be encoded and carried by the synchronization signals,
time offset between the synchronization signal and the LPWUS, and
number of instances of synchronization signals.

Below are two example approaches for re-establishing time and frequency synchronization to achieve various levels of accuracy in the remote UE 106:
Time/Frequency Re-Synchronization scheme 1 (TRS1): The relay UE 104, which is time/frequency synchronized with the network (e.g., with the base station 102), transmits a synchronization signal followed by a LPWUS. The remote UE 106 detects the synchronization signal and performs time/frequency re-synchronization (e.g., with the relay UE 104) based on the detected synchronization signal. The synchronization signal may occupy a certain amount of frequency bandwidth and/or contain multiple instances so that the time/frequency synchronization in the remote UE 106 can achieve an accuracy level which enable the remote UE 106 to communicate directly with the base station 102 after waking-up upon detecting the LPWUS.
Time/Frequency Re-Synchronization scheme 2 (TRS2): The relay UE 104, which is time-synchronized with the network (e.g., with the base station 102), transmits a simpler synchronization signal (e.g., a single carrier synchronization signal) followed by a LPWUS. A relaxed time synchronization is established between the remote UE 106 and the relay UE 104 so that the remote UE 106 is able to communication directly with the relay UE 104 after waking up upon detecting the LPWUS. This scheme can lead to further optimizations when there is only a limited amount of data to be transferred.

To reduce the amount of power consumed by the remote UE 106 to perform time/frequency synchronization and LPWUS detection, a time offset between the synchronization signal and the LPWUS can be optimized so that the remote UE 106 can keep its active duration as short as possible while detecting both the synchronization signal and the LPWUS. Thus, in one embodiment, the LWPUS immediately follows the synchronization signal (i.e., the LPWUS starts in the OFDM that immediately follows an OFDM symbol in which the synchronization signal, or one of multiple instances of the synchronization signal, is transmitted).

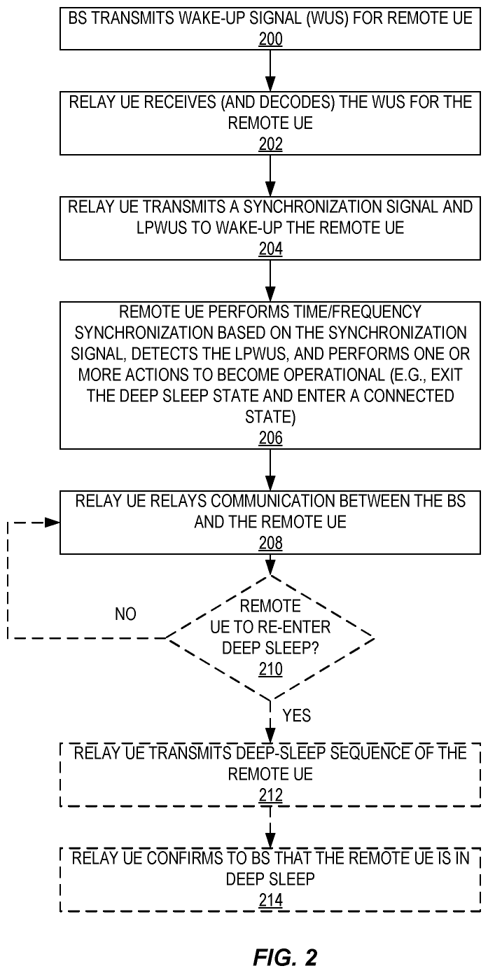

FIG. 2 is a flow chart that illustrates the operation of the base station 102, the relay UE 104, and the remote UE 106 in accordance with one embodiment of the present disclosure. Optional steps are denoted by dashed boxes/lines. As illustrated, in this embodiment, the base station 102 transmits a WUS containing the UE ID of the remote UE 106 (step 200). The relay UE 104 receives and decodes the WUS for the remote UE 106 (step 202). In other words, the relay UE 104 receives the WUS and decodes the WUS to determine that the WUS includes the UE ID of the remote UE 106. The relay UE 104 then generates and transmits a synchronization signal followed by a LPWUS to the remote UE 106 (step 204). More specifically, in one embodiment, the relay UE 104 transmits a synchronization signal. In addition, the relay UE 104 generates a LPWUS with a sequence based on the UE ID of the remote UE 106 and transmits the LPWUS following the synchronization signal. In one embodiment, the relay UE 104 transmits a single instance of the synchronization signal, and the LPWUS follows (e.g., immediately follows, e.g., in a next OFDM symbol) the single instance of the synchronization signal. In another embodiment, the relay UE 104 transmits multiple instances, or repetitions, of the synchronization signal, and the LPWUS follows (e.g., immediately follows, e.g., in a next OFDM symbol) one of the instances of the synchronization signal (e.g., immediately follows an k-th instance of the synchronization signal where N instances of the synchronization signal are transmitted and 1≤k≤N). Note that the LPWUS may be broadcast to all of the remote UEs 106 or may be unicast to the remote UE 106 for which it is intended via a respective D2D or 3GPP sidelink.

At the remote UE 106, the remote UE 106 performs time/frequency synchronization based on the synchronization signal and detects (e.g., receives and decodes) the LPWUS (step 206). In one embodiment, the LPWUS is encoded with the UE ID of the remote UE 106 and, as such, detection of the LPWUS includes determining that the UE ID with which the LPWUS is encoded matches the UE ID of the remote UE 106. In another embodiment, the LPWUS is encoded with a group ID of remote UEs 1106 (see details below regarding group WUS) and detection of the LPWUS includes determining that the group ID with which the LPWUS is encoded matches the group ID of the remote UE 106. Upon detecting the LPWUS (and determining that the encoded UE ID or group ID matches its own UE ID or group ID), the remote UE 106 performs one or more actions, e.g., to become operational (e.g., exists the deep-sleep mode and enters a connected mode) (step 206).

Once the remote UE 106 is operational, the remote UE 106 receives data from and/or transmits data to the relay UE 104 via a respective sidelink (step 208). Note that for uplink data transmission, once the relay UE 104 receives data from the remote UE 106, the relay UE 104 transmits the data to the base station 102. Likewise, for downlink data transmission, once the relay UE 104 receives data for the remote UE 106 from the base station 102, the relay UE 104 transmits the data to the remote UE 106 via the sidelink.

The relay node 104 may thereafter determine whether the remote UE 106 is to return to the deep-sleep mode (step 210). If so, in one embodiment, the relay UE 104 transmits a deep-sleep sequence of the remote UE 106 (step 212). The relay UE 104 may confirm to the base station 102 (e.g., upon receiving a deep-sleep ACK from the remote UE 106) that the remote UE 106 is in the deep-sleep state (step 214).

Now, some further description of aspects of the present disclosures related to time/frequency synchronization will be provided. In 3GPP LTE, a base station always broadcasts a Cell Reference Signal (CRS) which can be used by UE (e.g., a remote UE) to perform time/frequency synchronization. 3GPP NR does not specify this always-on broadcast signal from the NR base station (i.e., gNB), instead there are dedicated Synchronization Signal Blocks (SSBs) periodically broadcasted from a NR BS. By detecting SSB, a NR UE can perform time/frequency synchronization to the NR BS.

Assuming the relay UE 104 is always time/frequency synchronized with the network (e.g., with the base station 102), in one embodiment, a dedicated synchronization signal followed by the LPWUS may be transmitted/broadcast by the relay UE 104 (e.g., in step 204). By receiving the synchronization signal, the remote UE 106 (or a group of remote UEs 106) can perform frequency/time synchronization with the relay UE 104 so that it (or they) can correctly receive/decode the LPWUS following the synchronization signal.

Two example schemes for time/frequency re-synchronization, denoted herein as TRS1 and TRS2, are as follows.

TRS1: When the remote UE 106 is supposed to connect to the base station 102 after waking up, the relay UE 104 may configure its synchronization signal to the remote UE(s) 106 in the time and/or frequency domain and/or samples with better Signal to Noise Ratio (SNR) (e.g., via using more complex modulation and coding scheme). In one embodiment, in this case, the relay UE 104 may configure its synchronization signal to the remote UE(s) 106 with a more complex sequence occupying more RF resources in time and/or frequency domain (e.g. the synchronization signal transmitted by the relay UE 104 may be the sidelink synchronization signal specified in 3GPP LTE/NR) in order to guarantee high accuracy of time/frequency synchronization between the remote UE and the relay UE 104 and thus the base station 102. In other words, the amount of time and/or frequency domain resources occupied by the synchronization signal transmitted by the relay UE 104 (or the multiple instances of the synchronization signal transmitted by the relay UE 104) may be a function of whether the remote UE 106 is to communicate directly with the base station 102 after wake-up or is to communicate with the relay UE 104 (i.e., communicate with the base station 102 via the relay UE 104) after wake-up. For the former, more time and/or frequency resources are used in order to provide a sufficient level of time/frequency synchronization accuracy.

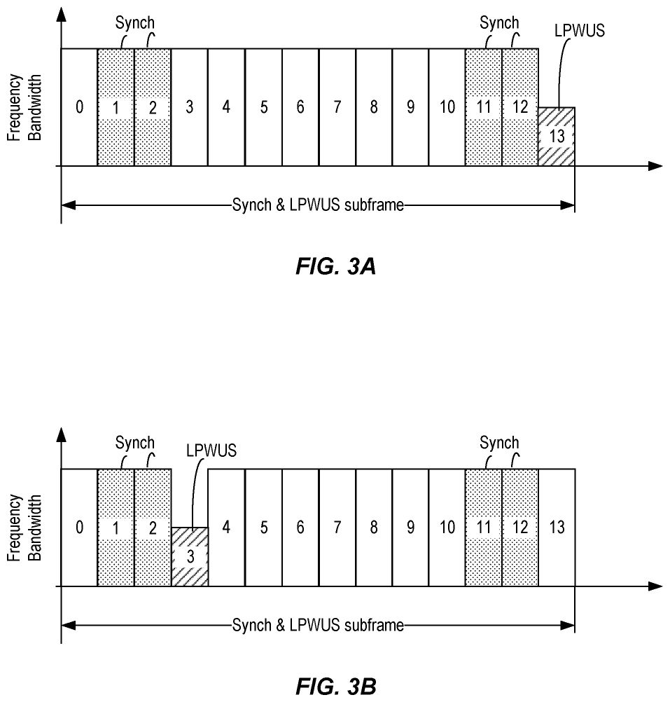

FIG. 3A shows an example of an LTE sidelink synchronization subframe including four synchronization symbols (symbols 1, 2, 11, and 12). In other words, the synchronization signal (or instances of the synchronization signal) is transmitted in symbols 1, 2, 11, and 12 in the example of FIG. 3A. These four synchronization symbols may be encoded by the ID of the relay UE 104. The subframe is transmitted by the relay UE 104. To wake up remote UEs 106 by the relay UE 104, in this example, symbol 13 is allocated for transmission of the LPWUS transmission (i.e., the LPWUS is transmitted in symbol 13 in this example). As shown in FIG. 3A, the four synchronization symbols may be allocated with higher bandwidth than the LPWUS. In other words, the synchronization signal may use a bandwidth that is greater than the bandwidth used for LPWUS.

Note that, in one alternative example, the LPWUS is transmitted in symbol 3 immediately following the second synchronization symbol (e.g., immediately following a second instance, or repetition, of the synchronization signal in symbol 2), as illustrated in FIG. 3B. This is to illustrate that, for example, the LPWUS need not necessarily follow the last instance of the synchronization signal (e.g., in a subframe), but may instead follow some prior instance of the synchronization signal (e.g., in the subframe). When the LPWUS is allocated between synchronization signals or between instances, or repetitions, of the synchronization signal (e.g., in symbol 3 as in FIG. 3B), the remote UE 106 may receive symbol 1 and 2 first, so that the remote UE 106 can be synchronized to the relay UE 104 and receive the following LPWUS. If the remote UE 106 finds the LPWUS is targeting the remote UE 106, it may then perform further time/frequency synchronization by receiving the synchronization signal instances, or repetitions, in additional symbols 11 and 12. Otherwise, it can skip the reception of the additional synchronization symbols.

To further optimize the power consumption of the remote UE 106, when the D2D SNR is high enough (e.g., above a predefined SNR threshold), the remote UE 106 may only receive a partial bandwidth of the synchronization signals. For example, the remote UE 106 may receive the synchronization signal (e.g., in symbols 1 and 2 of the examples of FIGS. 3A and 3B) with the same bandwidth as the LPWUS reception. The remote UE 106 can still be synchronized and receive the following LPWUS. If the remote UE 106 finds the LPWUS is targeting the remote UE 106, it may then further time/frequency synchronization by receiving the synchronization signal in symbols 11 and 12 with full bandwidth, and wakeup its main receiver. Otherwise, it can skip the reception of the additional synchronization symbols.

In one embodiment, the relay UE 104 may transmit additional synchronization signal(s) with a time offset to the LPWUS where the time offset is configured according to the duration of the wakeup process of the remote UE 106. When the remote UE 106 completes its wakeup process (which is triggered by the LPWUS), it can receive the synchronization signals and perform time/frequency synchronization. The remote UE 106 can receive the synchronization signal and perform time/frequency synchronization.

As multiple symbols with high bandwidth can be used for the synchronization signal, high synchronization accuracy can be achieved between the remote UE 106 and the relay UE 104 (and also the base station 102). For example, after being woken-up by the LPWUS, the remote UE 106 can start a random access to set up radio connection with the base station 102.

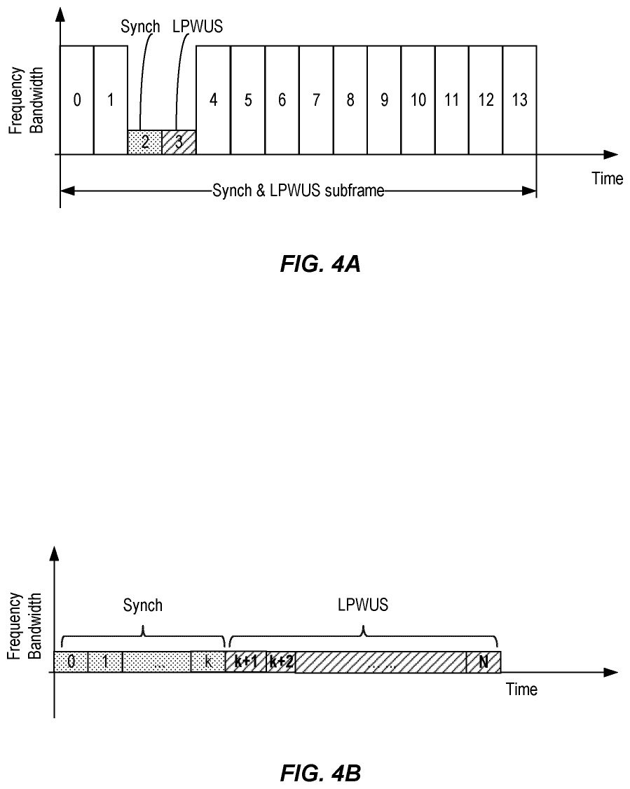

TRS2: When the remote UE 106 is not supposed to connect to the base station 102 after waking up, the relay UE 104 may configure its synchronization signal to the remote UE 106 with a simpler sequence occupying less RF resources in the time and/or frequency domain. As example is shown in FIG. 4A where the synchronization signal is transmitted is symbol 2 in a reduced bandwidth, and the LPWUS is transmitted in symbol 3 also in a reduced bandwidth. Using this simpler sequence, a relaxed time synchronization is established between the remote UE 106 and the relay UE 104 serving the needs for their sidelink communication. This scheme can be further optimized when there is only a limited amount of data to be transferred, and the relay UE 104 can act as a proxy for such data transfer and service requests. For example, when a simple modulation scheme (e.g., OOK) is applied to transfer small amount of data between the relay UE 104 and the remote UE 106, the sidelink can tolerate higher time/frequency synchronization errors (compared with TRS1) so the synchronization signal can be simplified, e.g., a single-tone signal can be used. Another example is illustrated in FIG. 4B. In this example, OOK modulation may be used where the synchronization signal and the LPWUS can be longer than 1 OFDM symbol.

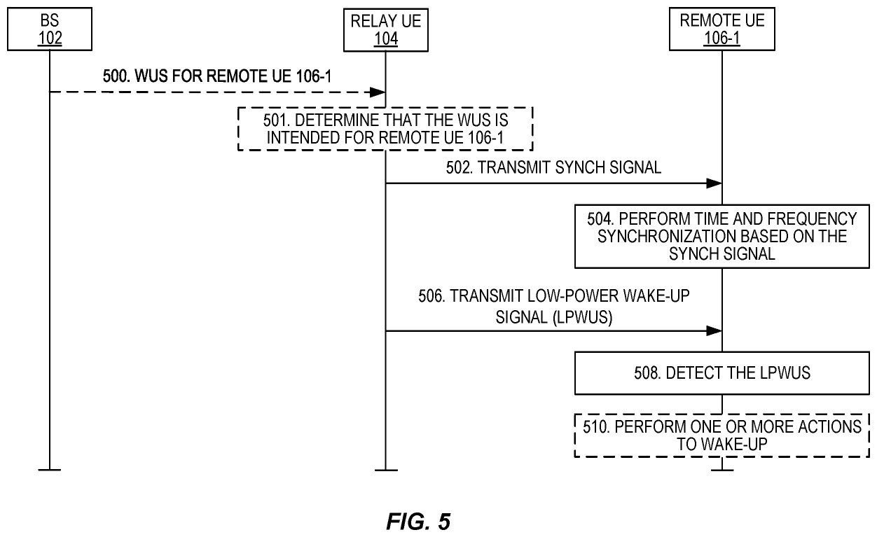

FIG. 5 illustrates the operation of the base station 102, the relay UE 104, and the remote UE 106-1 (in this example), in accordance with at least some of the embodiments described above. Optional steps are denoted with dashed lines/boxes.

As illustrated, the base station 102 transmits a WUS that includes, is encoded with, or otherwise indicates the remote UE 106-1 (step 500). The relay UE 104 receives the WUS and determines that the WUS is intended for the remote UE 106-1 (step 501). The relay UE 104 transmits a synchronization signal (step 502). The remote UE 106-1 performs time/frequency synchronization based on the synchronization signal (step 504). The relay UE 104 also generates and transmits a LPWUS to the remote UE 106-1 (step 506). Note that the synchronization signal and the LPWUS may be in accordance with any of the embodiments described above. The relay UE 106-1 detects (i.e., receives and decodes) the LPWUS (step 508). Responsive to detecting the LPWUS, the remote UE 106-1 performs one or more actions to wake-up (step 510).

In one embodiment, the LPWUS has a bandwidth that is less than that of a WUS (e.g., the WUS of step 500) from the base station 102. In one embodiment, the LPWUS has a bandwidth that is less than 180 kilohertz (kHz). In one embodiment, the LPWUS is transmitted in at least one OFDM symbol. In one embodiment, the synchronization signal and the LPWUS are transmitted in a same subframe. In one embodiment, transmitting the synchronization signal in step 502 includes transmitting two or more instances, or repetitions, of the synchronization signal. The repetitions may be transmitted in the time domain and/or the frequency domain. In one embodiment, at least one repetitions of the synchronization signal is transmitted prior to the LPWUS. In one embodiment, all of the repetitions of the synchronization signal (e.g., in a subframe) are transmitted prior to the LPWUS (e.g., in the same subframe). In one embodiment, the two or more repetitions of the synchronization signal and the LPWUS are transmitted in a same subframe.

In one embodiment, a bandwidth of the synchronization signal is greater than a bandwidth of the LPWUS. In one embodiment, the bandwidth of the synchronization signal is less than or equal to a full receive bandwidth of the remote UE 106-1. In one embodiment, the remote UE 106-1 is an IoT UE. In one embodiment, the full receive bandwidth of the remote UE 106-1 is either 1.4 Megahertz (MHz) or 180 KHz. In one embodiment, a single instance of the synchronization signal is transmitted. In one embodiment, this single instance of the synchronization signal is transmitted in at least one OFDM symbol that immediately precedes the LPWUS. In one embodiment, a bandwidth of the synchronization signal is less than a full receive bandwidth of the remote UE 106-1. In one embodiment, the remote UE 106-1 is an IoT UE. In one embodiment, the full receive bandwidth of the remote UE 106-1 is either 1.4 MHz or 180 KHz.

In one embodiment, a bandwidth of the synchronization signal is the same as a bandwidth of the LPWUS.

In one embodiment, at least one instance of the synchronization signal is transmitted in at least one OFDM symbol that immediately precedes an OFDM symbol in which the LPWUS is transmitted.

In one embodiment, either or both of a bandwidth of the synchronization signal and a bandwidth of the LPWUS is a function of one or more metrics related to one or more characteristics of a wireless channel between the relay UE 104 and the remote UE 106-1.

In one embodiment, either or both of a modulation or coding of the synchronization signal and a modulation or coding of the LPWUS is a function of one or more metrics related to one or more characteristics of a wireless channel between the relay UE 104 and the remote UE 106-1. In one embodiment, a transmit power used for transmitting the synchronization signal or the LPWUS is a function of the modulation or coding of the synchronization signal or the LPWUS, respectively.

In one embodiment, the LPWUS is encoded with an ID of the remote UE 106-1 or an ID of a group of remote UEs 106.

In one embodiment, the relay UE 104 unicasts the synchronization signal and/or the LPWUS to the remote UE 106-1. In another embodiment, the relay UE 104 broadcasts the synchronization signal and/or the LPWUS to multiple remote UEs 106 including the remote UE 106-1.

It should be noted that while the embodiments described herein focus on the LPWUS, the embodiments can be extended to additionally or alternatively apply to a Go-To-Sleep (GTS) signal which is transmitted by the base station 102 and a Low-Power GTS (LPGTS) signal transmitted from the relay UE 104 to the remote UE 106-1 to cause the remote UE 106-1 to enter the deep-sleep state.

II. Relayed Group Wake-Up Existing wake-up mechanisms, including both the WUS signaling mechanism defined in 3GPP LTE and WUS signaling mechanism via a relay UE as proposed in the '017 Application, assume a one-to-one wake up signaling (from base station to a single device at a time). Arguably, these wake-up mechanisms are sub-optimal because they require numerous sequential wake-up processes (depending on the population of the IoT UEs) to run by the base station, resulting in increased delay and energy usage.

Systems and methods are disclosed herein that address the aforementioned and/or other problems associated with conventional wake-up mechanisms. More specifically, systems and methods are disclosed herein for relayed group wake-up (i.e., relayed wake-up signaling for a group of remote UEs (e.g., a group of IoT UEs)).

Relayed group wake-up is more efficient in terms of delay and energy usage than existing wake-up mechanisms which rely on one-to-one wake-up signaling. Moreover, IoT UEs, due to their mission and service function types, could show very high similarity patterns in terms of geographic distribution, traffic type, and radio propagation status. Therefore, similar IoT UEs can be grouped, and wake up signaling can be performed in group-wise fashion so as to enhance the wake-up signaling efficiency.

Embodiments are disclosed herein for relayed group wake-up of a group of remote UEs (e.g., a group of IoT UEs such as, e.g., a group of sensors) and subsequent data transfer between a base station and the remote UEs via the relay UE. The rationale of relayed wake-up is that the distance between the relay UE and the remote UE (or group of remote UEs) is much shorter than the distance between base station and the remote UE (or group of remote UEs) making such a system more robust and leading to lower power consumption in the remote UE (or group of remote UEs). The rationale behind group wake-up is that remote UEs may bear similarities (e.g., in terms of service function types, traffic pattern, geographic distribution etc.) and, therefore, similar remote UEs can be grouped together and wake-up signaling can be performed in group-wise fashion. This enhances the efficiency of wake-up process in terms of latency and energy used for signaling without affecting the normal operation of individual remote UEs. Furthermore, the overhead for the base station is substantially lower since the relay UE manages the wake-up procedures via sidelink communication.

By introducing relay nodes and group wake-up mechanisms, the embodiments of the present disclosure enable ultra-low-power devices to enter/exit deep sleep without having to communicate directly with the base station, both during the relayed wake up signaling or re-synchronization signaling after the initial relayed wake-up signal.

Multiple aspects are described herein in relation to relayed group wake-up. These aspects may potentially be used independently from one another but may be used in combination. These aspects support a much more energy efficient and robust system enabled by relayed group wake-up. These aspects include:
1. Relayed group wake-up, where the relay UE is managing the wake-up, re-synchronization, and potential support for handling service requests, to a group of remote UEs.
2. Guidelines for grouping of remote UEs based on different similarity metrics.
3. Dynamic allocation of a group (or multiple groups) of remote UEs to a relay UE out of multiple candidate relay UEs.
4. Mechanisms and procedures for re-establishing time synchronization of the group of remote UEs after deep sleep.
5. Hierarchical wake-up, where an additional layer(s) of relay is introduced. This further increases the robustness and coverage of the system.
6. Overlapping wake-up groups.

Embodiments of the present disclosures related to relayed wake-up may provide one or more of the following advantages:
enable better coverage for devices that go in deep sleep,
enable lower uplink transmit power from remote UEs upon wake-up,
lead to more robust support for ultra-low-power devices entering deep-sleep via repeat wake up requests for selected wake up of unresponsive remote UEs,.
allow for a simpler and lower power wake-up receiver mode within a WUS receiver that can also wake up based on a WUS from a base station.

Embodiments of the present disclosures related to group wake-up may provide one or more of the following advantages:
enhancement of the efficiency of wake-up procedure by minimizing the signaling overhead via simultaneous wake-up signaling to group of nodes,
differentiated wake-up solution through grouping of remote UEs and allocation of groups to different relay UEs,
reduced signaling overhead via (multicast) group re-synchronization instead of individual node by node fashion.

Embodiments of the present disclosures related to hierarchical wake-up may provide one or more of the following advantages:
ability to create an even more robust system with longer reach into areas not covered by the base station,
enable sequential wake-up where a remote UE in deep sleep, when it has been woken-up, can further manage of wake-up to additional units.

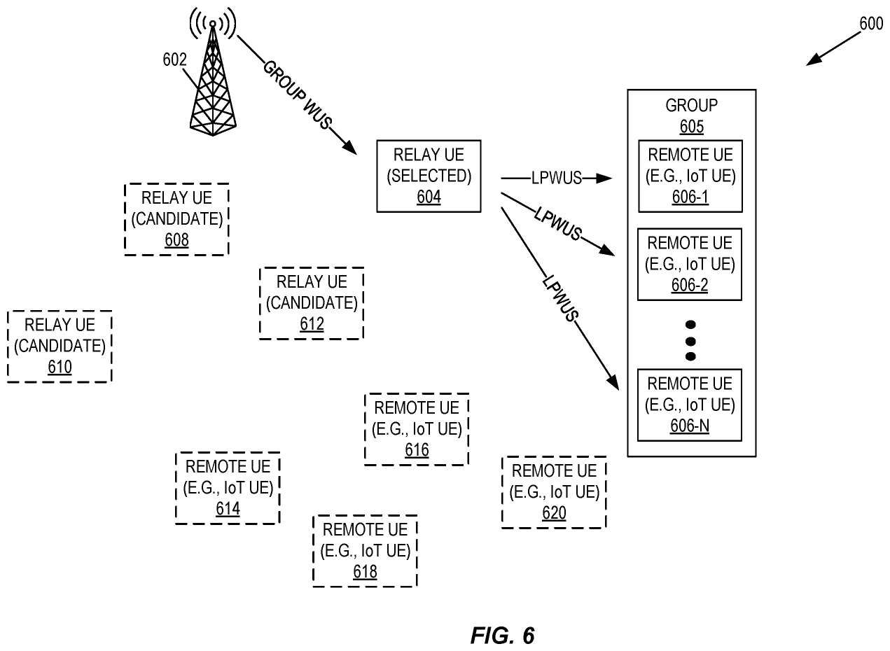

In this regard, FIG. 6 illustrates a system 600 in which relayed group wake-up signaling may be used in accordance with one example embodiment of the present disclosure. As illustrated, the system 600 includes a base station 602 and a relay UE 604 that operates to provide relayed group wake-up signaling for a group 605 of remote UEs 606-1 to 606-N, which are generally referred to herein collectively as remote UEs 606 and individually as remote UE 606. The relay UE 604 also acts as a proxy between the base station 602 and the remote UEs 606. The remote UEs 606 may be, for example ultra-low power IoT UEs. The remote UEs 606 operate in a deep sleep mode of operation (e.g., an idle mode) until woken up by a WUS. In addition, the remote UEs 606 could be in a non-coverage region (i.e., they may have very poor RF link to the base station 602 such that no or limited radio signal from the base station 602 can be received by the remote UEs 606 in the non-coverage region). A non-coverage region may also be referred to as a shadow region. In relayed group wake-up, the relay UE 604 is the link between the base station 602 and the remote UEs 606 in the group 605, where the remote UEs 606 may enter deep sleep mode and need to be activated by a wakeup signal. The relay UE 604 then manages, among other things, wake-up of the remote UEs 606.

The base station 602 is aware, e.g., as a result of authentication procedures, of remote UEs 606 and optionally remote UEs 614, 616, 618, and 620 in an area. The base station 602 can further identify a UE (or multiple UEs) in the vicinity as a candidate relay UEs(s) to these remote UEs 606, 614, 616, 618, and 620. For example, the base station 602 may estimate the locations of the UEs under its coverage and select UEs close to the remote UEs 606, 614, 616, 618, and 620 as candidate relay UEs. If a remote UE is introduced into the system 600 and has no immediate connection to the base station 602, this remote UE may search for potential relay UEs. This can be solved by, e.g., a conventional D2D peer discovery process. For example, the remote UE may periodically wake-up and listen for a reference signal (e.g., synchronization signal) from a relay UE. If it detects the reference signal and decodes the relay ID, it can setup a D2D, or sidelink, channel to the relay UE.

Furthermore, from measurement reports received by the base station 602, the base station 602 builds an understanding of the coverage/signal strength, UE transmit power, UE mobility, etc. and then, using this information, creates the group 605 of remote UEs 606 and selects the relay UE 604 for the group 605 of remote UEs 606. The base station 602 notifies both the relay UE 604 and the remote UEs 606 of the pairing. For example, the base station 602 may send the UE IDs of the remote UEs 606 to the relay UE 604 and/or inform the remote UEs 606 of the relay ID of the relay UE 604. Further, the base station 602 may send the group ID of the group 605 of remote UEs 606 to the relay UE 604 and, in some embodiments, the remote UEs 606 in the group 605. Once a pairing acknowledgement is received by the base station 602 from each of the remote UEs 606 directly (or in some embodiments via the relay UE 604 on behalf of the individual remote UEs 606), the base station 602 notifies the remote UEs 606 via the relay UE 604 that they can go into a deep sleep mode and, upon reception of a wake-up signal, should communicate with the relay UE 604, whose relay ID was shared during the pairing.

When the base station 602 desires to wake-up and fetch data from the group 605 of remote UEs 606, either by an explicit request from the base station 602 or because it is acting as a proxy for certain services and identifies the need to wake-up the group 605 of remote UEs 606, the relay UE 604 wakes-up the group 605 of remote UEs 606. The relay UE 604 checks if each of the remote UEs 606 in the group 605 is woken-up and establishes time synchronization. More specifically, in one embodiment, the base station 602 transmits a WUS which includes a group ID of the group 605 of remote UEs 606. This WUS is referred to herein as a “group WUS”. As described below in detail, the relay UE 604 operates to receive and decode the group WUS on behalf of the group 605 of remote UEs 606. The relay UE 104 then generates and transmits a WUS (e.g., a LPWUS such as that described in Section I above) to each of at least a subset of the group 605 of remote UEs 606 so that the remotes UE 606 in the group 605 for which the group WUS from the base station 602 is intended are woken-up. Note that, in one embodiment, the relay UE 604 sends a WUS (e.g., a LPWUS) to each remote UE 606 in the group 605. In another embodiment, the relay UE 604 first listens for ACKs, to the group WUS, from the remote UEs 606 in the group 605 and sends a WUS (e.g., a LPWUS) to only those remote UEs 606 in the group 605 for which it does not detect an ACK. In one embodiment, each LPWUS transmitted by the relay UE 604 is encoded with the UE ID of the respective remote UE 606. In addition, in one embodiment, the relay UE 604 supports the establishment of time re-synchronization for the remote UEs 606 (e.g., by transmitting both a synchronization signal and a LPWUS to each remote UE 606 as described above in Section I). Once the remote UEs 606 in the group 605 are woken-up, the relay UE 604 provides data transfer between the base station 602 and the remote UEs 606.

Note that a suitable candidate relay UE is a UE that is in an acceptable radio channel condition with respect to the base station 602. A suitable candidate relay UE should not have to go into deep sleep itself (although not mandatory) and it should support the signaling schemes to wake up other UEs. Furthermore, a suitable candidate relay UE should have good connection with the remote UEs 606 in the group 605 that are to enter deep sleep. The larger the number of remote UEs 606 with good coverage by a candidate relay UE, the better chance for the candidate relay UE to actually serve as relay UE, albeit bounded to a maximum number of remote UEs that can be handled by this relay UE. There are different criteria and approaches for how to appoint multiple remote UEs into a group for group wake-up, which are described below in detail.

In some embodiments, when remote UE 606 wakes up, it may perform a sanity-check to determine whether the paired relay UE 604 is responding to its requests. In some other embodiments, the remote UE 606 can skip this procedure and directly initiate communication with the relay UE 604 whose relay ID was obtained by the remote UE 606 before entering deep sleep.

It should be noted that there are several different group wake-up scenarios where additional mechanisms are proposed to further optimize for energy efficiency. These additional mechanisms may include any one or more of the following:
In one embodiment, the remote UEs 606 in the group 605 communicate with the base station 602 or network service, via the relay UE 604, and act upon requests, such as, e.g., probing for measuring data, to receive new settings, or whatever services will be requested over the communication channels. Each remote UE 606 has a dedicated communication channel to the base station 602 via the relay UE 604.
In one embodiment, the remote UEs 606 in the group 605 are treated by a network-based service(s) as one group. Individual group commands or data transfers are sent from the base station 602 to the relay UE 604, acting as a proxy to the group 605. Instead of relaying from the base station 602 to each remote UE 606 in the group 605 individually, the relay UE 604 multicasts the commands/transfers to all of the remote UEs 606 in the group 605. This is similar to multicast support but managed by the relay UE 604 and optionally also including acknowledgements from the remote UEs 606.
In one embodiment, the relay UE 604 acts fully as a proxy for service requests. The relay UE 604 pushes data to or polls data from the remote UEs 606 in the group 605 as they have been woken up and then commands them to go back to deep sleep.
In one embodiment, the grouping of the remote UEs 606 could be based on the similarity of UE roles, traffic patterns, and spatial/geographic distribution, and/or other criteria. The spatial/geographic distribution criterion could benefit a differentiated wake-up signaling for different groups with different spatial/geographic features, i.e. farther groups or shadowed groups will be signaled with more robust signaling or with higher transmit power by the relay UE 604. UE grouping based on geographic proximity could also serve better beamforming in the relay UE 604 in order to increase WUS robustness and/or minimizing interference with neighboring groups.
   a. Grouping of Remote UEs and Assigning Groups of Relay UEs

Establishment of groups can be performed in the appointment of relay UEs (e.g., the relay UE 604) such that a group wake-up request from the base station 602 to the relay UE (e.g., the relay UE 604) initiates the procedure of waking up the group of remote UEs (e.g., the group 605 of remote UEs 606). In another embodiment, the base station 602 can request the wake-up of a group by providing the identities of which remote UEs are to be woken up. In both these scenarios, the relay UE 604 is responsible for the complete wake-up sequences, including time re-synchronization, for all of the remote UEs 606 in the group 605. In one embodiment, if there are remote UEs 606 that do not wake-up, the relay UE 604 sends information about this to the base station 602, and the base station 602 then performs one or more actions to migrate those remote UEs 606 or the group 605 of remote UEs 606 to another relay UE.

In regard to grouping, remote UEs may bear natural similarities. Any one or more of the following criteria can be applied to a similarity measure for grouping (aka clustering) of the remote UEs with regards to certain degrees in the similarity measure:
Mission (i.e., service function performed by the IoT UE)
Traffic patterns
Geographic distribution
Experienced radio propagation quality (e.g., severe radio shadow).

Note that the criteria above are only examples. Additional or alternative criteria may be used for grouping the remote UEs.

Each defined group of remote UEs is assigned to a relay UE. Note that a relay may be assigned at most one group of remote UEs. However, in another embodiment, a relay UE (e.g., the relay UE 604) may be assigned at most M groups of remote UES, where M is greater than or equal to 1. The value of “M” may, e.g., be based on criterion such as, e.g., a defined maximum number of remote UEs in a group, the number of UEs in the group(s) assigned to the relay UE, one or more capabilities of the relay UE, information about expected traffic patterns for the group(s) of remote UEs assigned to the relay UE, or the like. A group(s) of remote UEs are assigned to a relay UE based on one or more of the following factors:
the number of available (candidate) relay UEs;
geographic distribution of (candidate) relay UEs, e.g., distance to each other, distance to the base station 602, distance to the center of each group of remote UEs, or the like;
capabilities of the (candidate) relay UEs, e.g., reliability, signaling support, battery power, compute power, etc.;
If the remote UEs serve different purposes, the grouping is done according to services so the ones having the same functions or that need to be activated at similar times are grouped together. Then, one relay UE might be defined to act as a proxy for a certain function, which then naturally is related to a certain group of remote UEs.

In principle, the grouping and assigning of remote UEs to relay UEs can be jointly solved for optimization. As there are several different possible reasons to form groups, it is not in the scope of the present disclosure to limit the embodiments described herein to one or a few of them.

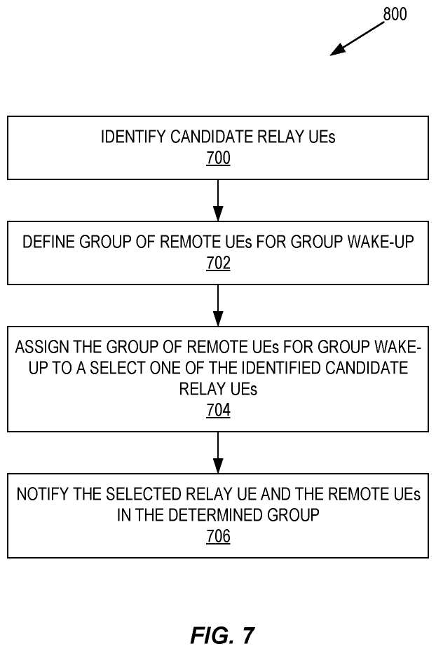

As illustrated in FIG. 7, in one embodiment, the grouping procedure contains the following steps:
Step 700: The base station 602 performs initial procedures to identify candidate relay UEs (e.g., candidate relay UEs 608, 610, 612, and the relay UE 604 which is ultimately selected for the group 605). The base station 602 could, for example, make use of the 3GPP Proximity Services functions for identification of the candidate relay UEs.
Step 702: Based on the system needs, the base station 602 defines groups of remote UEs, each to be served by a single relay UE. Groups can be defined based on, for example, service functions, geographic distribution of nodes, traffic patterns, frequency of wake-up, whether wake-up would be triggered by individual external events, and/or whether a relay UE will act as a service proxy for several remote UEs. As there are several different possible reasons to form groups, any desired criteria can be used for the grouping of remote UEs.
Step 704: The base station 602 appoints relay UEs to the defined groups of remote UEs (e.g., appoints the relay UE 604 to the group 605 of remote UEs 606 in the example of FIG. 6).
Step 706: The base station 602 notifies the relay UEs of the groups of remote UEs appointed to those relay UEs (including, e.g., the respective group IDs), and the relay UEs then confirm to the remote UEs in the respective groups.
   b. Group-Wake Up Solution and Signaling Mechanism(s)

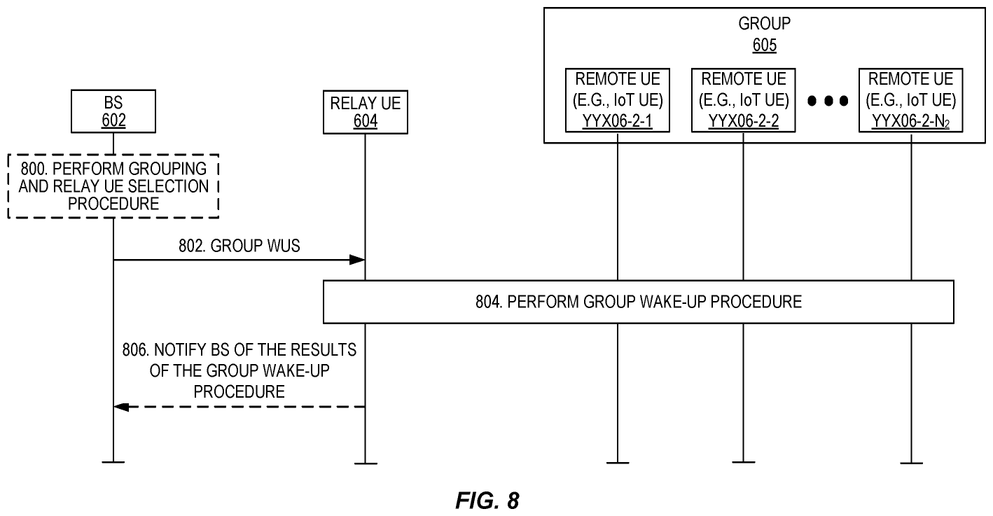

FIG. 8 illustrates the operation of the base station 602, the relay UE 604, and the group 605 of remote UEs 606 in accordance with one example embodiment of the present disclosure. Note that optional steps are represented by dashed lines/boxes. As illustrated, the base station 602 performs a procedure for grouping of remote UEs and relay UE selection for the defined groups, e.g., as described above with respect to FIG. 7 (step 800). Alternatively, the groups of remote UEs and the relay UEs to which the groups are assigned may be defined in another way, e.g., predefined and preconfigured by the appropriate configurations in the UEs. In this example, the group 605 of remote UEs 606 is defined and assigned to the relay UE 604.

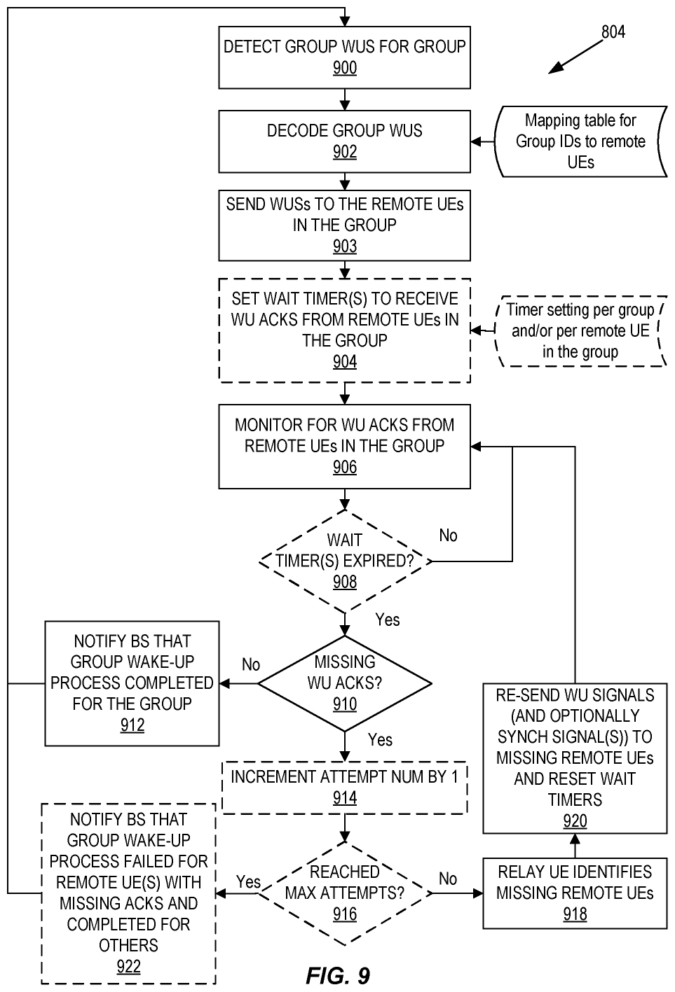

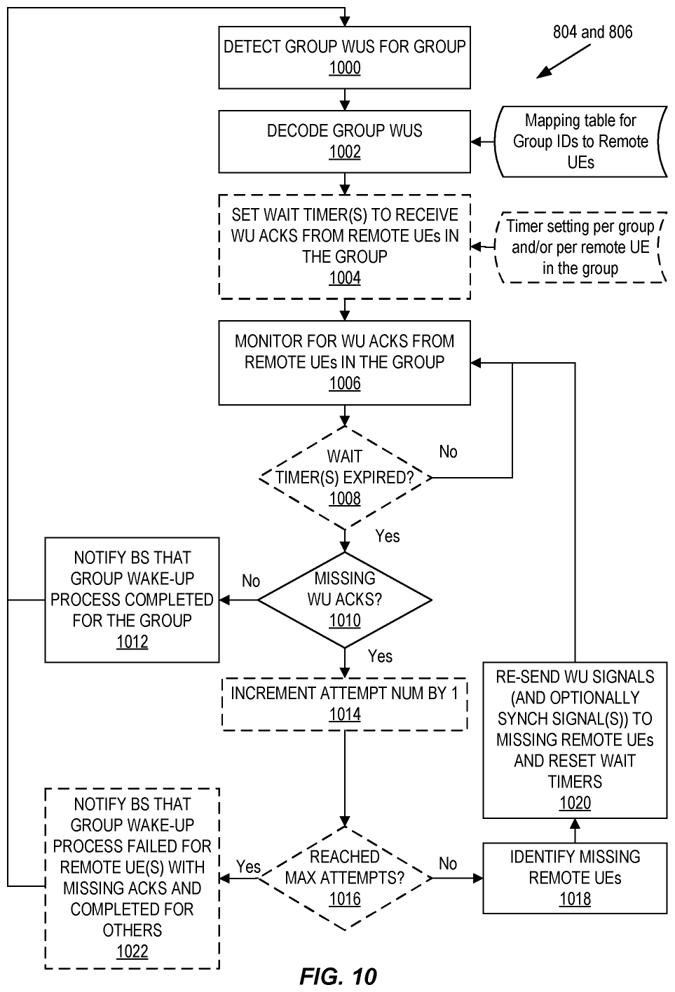

When wake-up of the group 605 of remote UEs 606 is desired, the base station 602 transmits a group WUS (step 802). The group WUS is encoded with or otherwise includes a group ID assigned to the group 605 of remote UEs 606. Upon detecting the group WUS for the group 605 of remote UEs 606, the relay UE 604 performs a group wake-up procedure whereby wake-up of the remote UEs 606 in the group 605 is performed (step 804). In one embodiment (see, e.g., FIG. 9), the relay UE 604 sends a separate WUS (e.g., a separate LPWUS) to each of the remote UEs 606 in the group 605 (or to the entire group at once) and, optionally, listens for WUS ACKs from the remote UEs 606. In another embodiment (see, e.g., FIG. 10 described below), the relay UE 604 first listens for group WUS ACKs from the remote UEs 606 in the group 605. The group WUS ACKs are sent by the remote UEs 606 upon detecting the group WUS from the base station 602 at the remote UEs 606. The relay UE 604 then transmits a separate WUS (e.g., a separate LPWUS) to each remote UE 606 in the group 605 for which the relay UE 604 did not detect a group WUS ACK.

The relay UE 604 then notifies the base station 602 of results of the group wake-up procedure (step 806). The results may include, for example, information that indicates the remote UEs 606, if any, there were not successfully woken-up. While not shown, the base station 602 may perform one or more actions based on the notification of step 806. For example, if all of the remote UEs 606 in the group 605 were successfully woken-up, the base station 602 may then proceed to send data or command(s) to the group 605 of remote UEs 606. As another example, if any of the remote UEs 606 in the group 605 were not successfully woken-up, the base station 602 may move those remote UEs 606 (i.e., the ones that were not successfully woken-up) or the group 605 of remote UEs 606 to a new relay UE.

FIG. 9 is a flow chart that illustrates steps 804 and 806 of FIG. 8 in more detail, in accordance with one example embodiment of the present disclosure. In other words, FIG. 9 is a flow chart that illustrates the operation of the relay UE 604 to perform a group wake-up procedure in accordance with one embodiment of the present disclosure. Optional steps are represented by dashed lines/boxes. As illustrated, the relay UE detects a group WUS for the group 605 of remote UEs 606 (step 900) and decodes the group WUS to obtain the group ID encoded in the group WUS (step 902). For example, the group WUS may be similar to a conventional WUS but encoded with the group ID of the group 605 of remote UEs 606.

In response to detecting the group WUS encoded with the group ID of the group 605 of remote UEs 606, the relay UE 604 generates and transmits a WUS (e.g., a LPWUS) to each of the remote UEs 606 in the group 605 (step 903). Note that IDs of the remote UEs 606 that are in the group 605 may be stored at the relay UE 606, e.g., in a look-up table based on the group ID. As described in section I above, in embodiments in which the relay UE 604 transmits a LPWUS to each of the remote UEs 606, the relay node 604 may transmit a synchronization signal in addition to the LPWUS to enable (re-) synchronization of the remote UEs to which the LWUS is transmitted. This is true for any of the embodiments described herein in which the relay UE 604 transmits a LPWUS to a remote UE 606.

The relay UE 604 then sets one or more timers to receive WUS ACKs from the remote UEs 606 in the group 605 (step 904). In one embodiment, a single timer is set for the group 605. In another embodiment, separate timers are set for the individual remote UEs 606 in the group 605, where different remote UEs 606 may have different timer values or the same timer value. While the timer(s) is (are) running, the relay UE 604 monitors for WUS ACKs from the remote UEs 606 in the group 605 (step 906).

Once the timer(s) has (have) expired (step 908, YES), the relay UE 604 determines whether any ACKs are missing (step 910). In other words, the relay UE 604 determines whether it has not detected a WUS ACK from any of the remote UEs 606 in the group 605. If none are missing (step 910, NO), the relay UE 604 notifies the base station 602 that wake-up of all of the remote UEs 606 in the group 605 is successful (step 912). If a WUS ACK was not detected for one or more of the remote UEs 606 in the group 605 (step 910, YES), the relay UE 604 increments an attempt count index (step 914) and determines whether a maximum number of wake-up attempts has been reached (step 916). The maximum number of attempts may be predefined or preconfigured and is an integer value greater than or equal to 1. Of course, the maximum number of wake-up attempts has an upper bound related to some defined or configured maximum acceptable amount of time that can be used for wake-up.

If the maximum number of wake-up attempts has not been reached (step 916, NO), the relay UE 604 identifies the remote UEs 606 in the group 605 for which WUS ACKs have not been received (step 918). The relay UE 604 re-sends a WUS signal (e.g., a LPWUS) to the identified remote UEs 606 and resets the timer(s) (step 920). Again, as described in section I above, in embodiments in which the relay UE 604 transmits a synchronization signal to each of the identified remote UEs 606, the relay node 604 may transmit a synchronization signal in addition to the LPWUS to enable (re-) synchronization of the remote UEs to which the LPWUS is transmitted. This is true for any of the embodiments described herein in which the relay UE 604 transmits a LPWUS to a remote UE 606.

After transmitting the WUS (e.g., LPWUS) to each of the identified remote UEs 606, the process then returns to step 906 where the relay UE 604 monitors for WUS ACKs from the remote UE(s) 606 to which the WUS was (re-) transmitted in step 920. This process continues until either WUS ACKs have been received from all of the remote UEs 606 in the group 605, in which case the relay node sends the notification in step 912, or until the maximum number of attempts has been reached. If the maximum number of attempts has been reached (step 916, YES), the relay UE 604 notifies the base station 602 that the group-wake up failed (step 922). This failure notification may include information that indicates the remote UE(s) 606 in the group 605 that have not been successfully woken up.

Note that if the relay UE 604 is assigned multiple groups of remote UEs, the relay UE 604 may perform the procedure of FIG. 9 sequentially for each group or for all of the groups in parallel.

FIG. 10 is a flow chart that illustrates steps 804 and 806 of FIG. 8 in more detail, in accordance with another example embodiment of the present disclosure. In other words, FIG. 10 is a flow chart that illustrates the operation of the relay UE 604 to perform a group wake-up procedure in accordance with one embodiment of the present disclosure. Optional steps are represented by dashed lines/boxes. As illustrated, the relay UE detects a group WUS for the group 605 of remote UEs 606 (step 1000) and decodes the group WUS to obtain the group ID encoded in the group WUS (step 1002). For example, the group WUS may be similar to a conventional WUS but encoded with the group ID of the group 605 of remote UEs 606. In response to detecting the group WUS encoded with the group ID of the group 605 of remote UEs 606, the relay UE 604 sets one or more timers to receive group WUS ACKs from the remote UEs 606 in the group 605 (step 1004). Note that the remote UEs 606 that are in the group may be stored at the relay UE 606, e.g., in a look-up table based on the group ID. In one embodiment, a single timer is set for the group 605. In another embodiment, separate timers are set for the individual remote UEs 606 in the group 605, where different remote UEs 606 may have different timer values or the same timer value. While the timer(s) is (are) running, the relay UE 604 monitors for group WUS ACKs from the remote UEs 606 in the group 605 (step 1006).

Once the timer(s) has (have) expired (step 1008, YES), the relay UE 604 determines whether any ACKs are missing (step 1010). In other words, the relay UE 604 determines whether it has not detected a group WUS ACK from any of the remote UEs 606 in the group 605. Note that, a remote UE 606, upon detecting the group WUS transmitted by the base station 602, transmits (e.g., broadcasts) a group WUS ACK including the UE ID of the remote UE 606. If none are missing (step 1010, NO), the relay UE 604 notifies the base station 602 that wake-up of all of the remote UEs 606 in the group 605 is successful (step 1012). If a group WUS ACK was not detected for one or more of the remote UEs 606 in the group 605 (step 1010, YES), the relay UE 604 increments an attempt count index (step 1014) and determines whether a maximum number of wake-up attempts has been reached (step 1016). The maximum number of attempts may be predefined or preconfigured and is an integer value greater than or equal to 1. Of course, the maximum number of wake-up attempts has an upper bound related to some defined or configured maximum acceptable amount of time that can be used for wake-up. In one embodiment, the maximum number of wake-up attempts is configured by the network (e.g., by the base station 602). In one embodiment, the maximum number of wake-up attempts is pre-configured before a group WUS is received. Any configuration changes after group WUS reception are carried out only for the next iteration of the group WUS. It should also be noted that the attempt number is reset upon decoding of the group WUS and before initial transmission of the LPWUS.

If the maximum number of wake-up attempts has not been reached (step 1016, NO), the relay UE 604 identifies the remote UEs 606 in the group 605 for which wake-up ACKs have not been received (either in response to the group WUS or some previous (LP) WUS attempt by the relay UE 604) (step 1018). The relay UE 604 (re-) sends a WUS signal (e.g., a LPWUS) to the identified remote UEs 606 and resets the timer(s) (step 1020). Note that the timer(s) may be reset to the same value(s) as used for monitoring upon detecting the group WUS or reset to a value(s) that is different than that used for monitoring upon detecting the group WUS. In one embodiment, for each iteration, a transmit power used by the relay UE 604 for resending the WUS is increased with respect to that used for the prior iteration. As described in section I above, in embodiments in which the relay UE 604 transmits a LPWUS to each of the identified remote UEs 606, the relay node 604 may transmit a synchronization signal in addition to the LPWUS to enable (re-) synchronization of the remote UEs to which the LWUS is transmitted. This is true for any of the embodiments described herein in which the relay UE 604 transmits a LPWUS to a remote UE 606.

After transmitting the WUS (e.g., LPWUS) to each of the identified remote UEs 606, the process then returns to step 1006 where the relay UE 604 monitors for WUS ACKs from the remote UE(s) 606 to which the WUS was (re-) transmitted in step 1020. This process continues until either wake-up ACKs have been received from all of the remote UEs 606 in the group 605, in which case the relay node sends the notification in step 1012, or until the maximum number of attempts has been reached. If the maximum number of attempts has been reached (step 1016, YES), the relay UE 604 notifies the base station 602 that the group-wake up failed (step 1022). This failure notification may include information that indicates the remote UE(s) 606 in the group 605 that have not been successfully woken up.

Note that if the relay UE 604 is assigned multiple groups of remote UEs, the relay UE 604 may perform the procedure of FIG. 10 sequentially for each group or for all of the groups in parallel.

c. Group Re-Synchronization

In one embodiment, in addition to sending the WUSs to the remote UEs 606 in the group 605, the relay UE 604 may transmit (e.g., unicast or broadcast) a set of time/frequency synchronization signals to the group 605 of remote UEs 606, e.g., via sidelink or D2D channel. By detecting the synchronization signals, the remote UEs 606 can perform time/frequency synchronization, e.g., to the relay UE 604. In one embodiment, the synchronization signals is encoded with the relay ID of the relay UE 604 so that the remote UEs 606 can also decode the group ID and understand which relay UE they are synchronized with. Furthermore, the synchronization signals and LPWUS can be bundled together and transmitted by the relay UE 604 (see, e.g., the description of the synchronization signal and LPWUS in Section I above).

d. Hierarchical Wake-Up

In one embodiment, hierarchical wake-up (i.e., hierarchical relayed wake-up) is provided. For hierarchical wake-up, at least one further level of relaying is introduced. This means that the relay UE that manages the wake up of a group of remote UEs (or an individual remote UE as in Section I above) does not connect directly to the base station. Instead, there is yet another relay node(s) in-between the relay UE and the base station. This concept is key to further increase the robustness and coverage of the system. There are different scenarios where this feature is beneficial:
In areas where certain remote UEs can be difficult to reach even with the appointed relay UE, one of the remote UEs that is not battery operated can be permanently or temporarily assigned as a second relay UE to secure a better wake-up coverage in that area.
Temporarily, a remote UE with good battery conditions can act as a wake-up relay for more distant remote UEs or remote UEs in especially poor RF conditions. That second relay UE can be either always on, meaning it does not enter deep-sleep itself, or it is allowed to enter deep-sleep but can support the more distant remote UEs as a relay after it has been woken up.

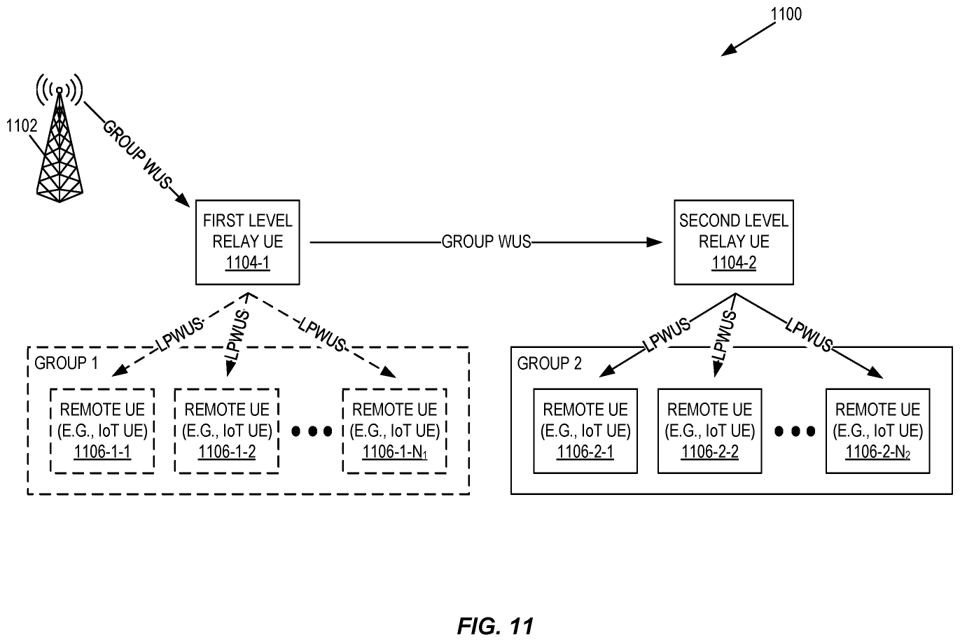

FIG. 11 illustrates one example of a system 1100 in which hierarchical wake-up is provided in accordance with an embodiment of the present disclosure. As illustrated, the system 1100 includes a base station 1102, a first relay UE 1104-1, and a second relay UE 1104-2. A group (Group 2) of remote UEs 1106 Feb. 1 to 1106-2-N₂ (generally referred to herein collectively as remote UEs 1106-2 and individually as remote UE 1106-2) is assigned to the second relay UE 1104-2. Optionally, another group (Group 1) of remote UEs 1106 Jan. 1 to 1106-1-N₁ (generally referred to herein collectively as remote UEs 1106-1 and individually as remote UE 1106-1) is assigned to the first relay UE 1104-1. In operation, when wake-up of Group 2 is desired, the base station 1102 transmits a group WUS encoded with a group ID of Group 2. The first relay UE 1104-1 relays the group WUS to the second relay UE 1104-2. The second relay UE 1104-2 detects the group WUS, decodes the group WUS to determine that it is intended for Group 2, and performs a group wake-up procedure for Group 2 as described above, e.g., with respect to FIG. 10 or FIG. 9.

In another embodiment, a larger group of remote UEs may be defined that includes both Group 1 and Group 2 shown in FIG. 11. In this case, a single group ID is assigned to this larger group. In other words, Group 1 and Group 2 shown in FIG. 11 have the same group ID. In this case, when wake-up of this larger group is desired, the base station 1102 transmits a group WUS that is encoded with the group ID of the larger group. The first relay UE 1104-1 relays the group WUS to the second relay UE 1104-2. In addition, the first relay UE 1104-1 decodes the group WUS and determines that the group ID matches that of the remote UEs 1106-1 in Group 1. The first relay UE 1104-1 then performs a group wake-up procedure for the remote UEs 1106-1 in Group 1 as described above, e.g., with respect to FIG. 10 or FIG. 9. The second relay UE 1104-2 detects the group WUS, decodes the group WUS to determine the group ID, determines that the group ID matches that of the remote UEs 1106-2 in Group 2, and performs a group wake-up procedure for Group 2 as described above, e.g., with respect to FIG. 10 or FIG. 9.

e. Overlapping Groups

In one embodiment, there may be overlapping groups of remote UEs for group wake-up. In this case, a remote UE(s) simultaneously belongs to two or more different groups. In an extreme case, there is a set of remote UEs where all of them belong to two groups, GA and GB, managed by two separate relay UEs, RA and RB. Note, however, that there are many different configurations and scenarios involving more than two groups and groups that are only partly overlapping. All such configurations and scenarios can be used.

One advantage of overlapping groups is that overlapping groups can be used to provide redundancy and hence robustness to the system. For example, if conditions are varying, the likelihood that a particular remote UE can be reached by one of the relay UEs increases if that remote UE belongs to two or more groups assigned to different relay UEs. Another benefit is that it is not as critical that a remote UE be migrated between to a new relay UE when that remote UE is not woken-up by a WUS from its relay UE. This is particularly beneficial if, in varying conditions, the remote UE would be migrated back and forth between the same two (or more) relay UEs. Using overlapping groups, this remote UE can belong to two (or more) groups assigned to the two (or more) relay UEs. Another advantage is that, when relay UEs act as proxies for certain types of services, they can connect to all remote UEs belonging to those services and, since a remote UE might support multiple different services or functions, the remote UE can belong to multiple different groups for the multiple different services or functions that it supports. Another advantage is that overlapping groups enable back-up of a relay UE. So, if for example RA in above scenario by some reasons fail, there is already RB supporting the same group that can be activated.

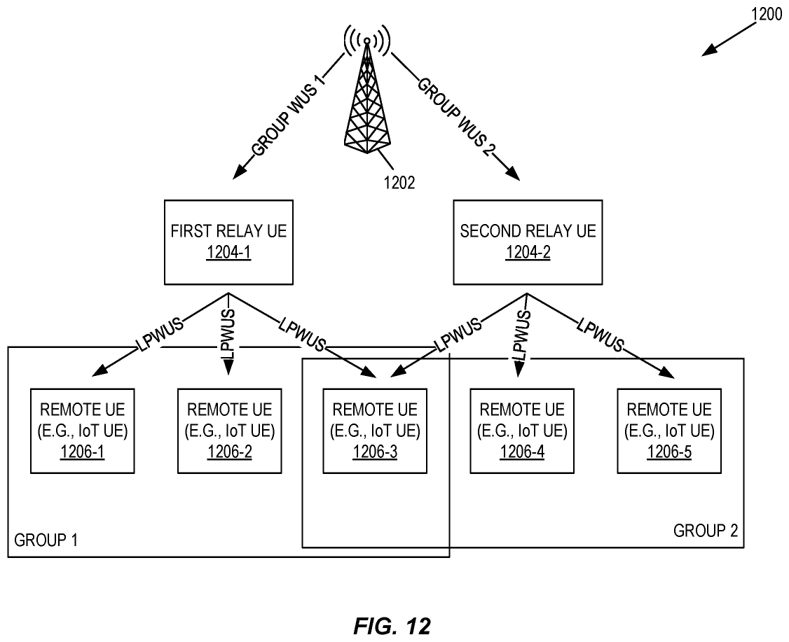

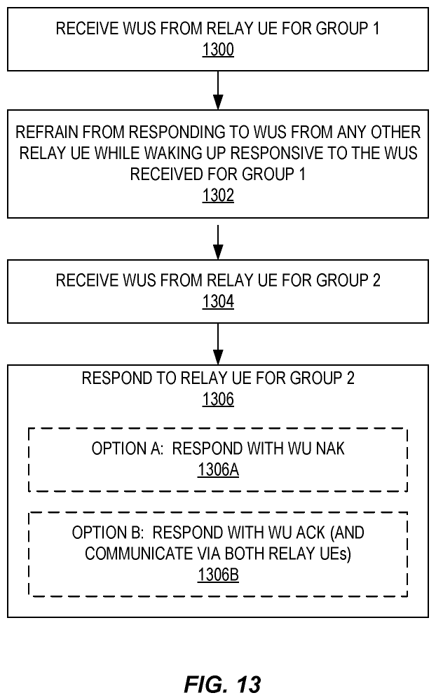

In this regard, FIG. 12 illustrates one example of a system 1200 that provides relayed group wake-up with overlapping groups in accordance with an embodiment of the present disclosure. As illustrated, the system 1200 includes a base station 1202, a first relay UE 1204-1, a first group (Group 1) of remote UEs 1206-1, 1206-2, and 1206-3 assigned to the first relay UE 1204-1, a second relay UE 1204-2, and a second group (Group 2) of remote UEs 1206-3, 1206-4, and 1206-5 assigned to the second relay UE 1204-2. Thus, in this example, Group 1 and Group 2 overlap and, specifically, the remote UE 1206-3 simultaneously belongs to both Group 1 and Group 2. Thus, the remote UE 1206-3 can, as part of group wake-up for Group 1, receive a WUS (e.g., a LPWUS) from the first relay UE 1204-1 and, as part of group wake-up for Group 2, receive a WUS (e.g., a LPWUS) from the second relay UE 1204-2.

Whereas overlapping groups provide robustness and flexibility, it comes with one key complication. Overlapping groups implies that, in some embodiments, a remote UE (e.g., the remote UE 1206-3 of FIG. 12) can receive WUSs from more than one relay UE. In this regard, FIG. 13 is a flow chart that illustrates the operation of a remote UE that is simultaneously in two or more groups in accordance with one embodiment of the present disclosure. Optional steps are represented by dashed lines/boxes. For this description, the remote UE 1206-3 of FIG. 12 is used as an example. As illustrated, the remote UE 1206-3 receives a WUS (e.g., a LPWUS) from the first relay UE 1204-1 (step 1300). After the remote UE 1206-3 has been activated based on the WUS from the first relay UE 1204-1, the remote UE 1206-3, during its initialization/re-synchronization phase, does not respond to other relay UEs (step 1302). In other words, the remote UE 1206-3 refrains from responding to other relay UEs while waking up in response to the WUS from the first relay UE 1204-1. In this example, sometime after waking up, the relay UE 1206-3 receives a WUS from the second relay UE 1204-2 for the second group (step 1304). The relay UE 1206-3 responds to the second relay UE 1204-2 (step 1306). In one embodiment, the response is a wake-up NAK (step 1306A). This wake-up NAK may indicate that the remote UE 1206-3 has already been woken-up by another relay UE.

In another embodiment, the remote UE 1206-3 responds to the second relay UE 1204-2 with a wake-up ACK and communicates via both the first relay UE 1204-1 and the second relay UE 1204-2 (step 1306B). This may be beneficial in a scenario where the different relay UEs 1204-1 and 1204-2 are managing different services. In this scenario, it might be relevant for the remote UE 1206-3 to respond to communication from both the first relay UE 1204-1 and the second relay UE 1204-2 while in active mode. This can be handled according to different approaches, which is decided at a system-level:
In one embodiment, only the first relay UE 1204-1 that woke up the remote UE 1206-3 acts as a proxy. Then, service requests from the second relay UE 1204-2 are communicated via the first relay UE 1204-1, potentially via the base station 1202. This is more complex from a system perspective but simplifies the scheme from the perspective of the remote UE 1206-3, and the re-synchronization at the remote UE 1206-3 need only be set for communicating via sidelink to the relay UE 1204-1. Go-to-sleep signaling can then come from one relay UE—the first relay UE 1204-1 that sent the first WUS.
In another embodiment, the remote UE 1206-3 can, after it is woken up, communicate via separate sidelinks with both the first relay UE 1204-1 and the second relay UE 1204-2. This scenario is simpler from an overall system perspective, as the relay UEs 1204-1 and 1204-2 can act independently to serve different needs. It adds some complexity on the remote UE 1206-3 as it needs to communicate via sidelink to two different relay UEs. In one embodiment, the remote UE 1206-3 does not re-enter deep sleep until receiving requests to do so from both the first relay UE 1204-1 and the second relay UE 1204-2.

### III. Further Details

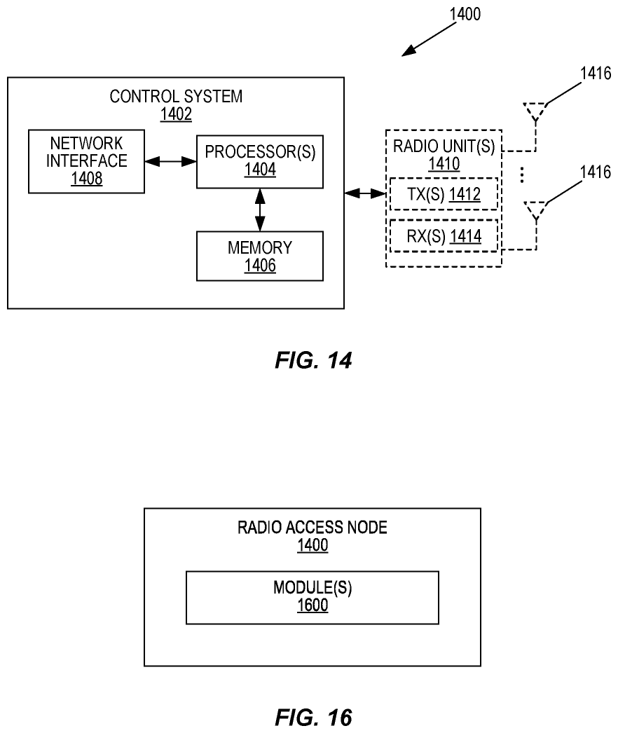

FIG. 14 is a schematic block diagram of a radio access node 1400 according to some embodiments of the present disclosure. Optional features are represented by dashed boxes. The radio access node 1400 may be, for example, the base station 102, 1102, or 1202 or a network node that implements all or part of the functionality of the base station 102, 1102, or 1202 described herein. As illustrated, the radio access node 1400 includes a control system 1402 that includes one or more processors 1404 (e.g., Central Processing Units (CPUs), Application Specific Integrated Circuits (ASICs), Field Programmable Gate Arrays (FPGAs), and/or the like), memory 1406, and a network interface 1408. The one or more processors 1404 are also referred to herein as processing circuitry. In addition, the radio access node 1400 may include one or more radio units 1410 that each includes one or more transmitters 1412 and one or more receivers 1414 coupled to one or more antennas 1416. The radio units 1410 may be referred to or be part of radio interface circuitry. In some embodiments, the radio unit(s) 1410 is external to the control system 1402 and connected to the control system 1402 via, e.g., a wired connection (e.g., an optical cable). However, in some other embodiments, the radio unit(s) 1410 and potentially the antenna(s) 1416 are integrated together with the control system 1402. The one or more processors 1404 operate to provide one or more functions of a radio access node 1400 as described herein (e.g., one or more functions of the base station 102, 1102, or 1202 as described herein). In some embodiments, the function(s) are implemented in software that is stored, e.g., in the memory 1406 and executed by the one or more processors 1404.

FIG. 15 is a schematic block diagram that illustrates a virtualized embodiment of the radio access node 1400 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1400 in which at least a portion of the functionality of the radio access node 1400 is implemented as a virtual component(s) (e.g., via a virtual machine(s) executing on a physical processing node(s) in a network(s)). As illustrated, in this example, the radio access node 1400 may include the control system 1402 and/or the one or more radio units 1410, as described above. The control system 1402 may be connected to the radio unit(s) 1410 via, for example, an optical cable or the like. The radio access node 1400 includes one or more processing nodes 1500 coupled to or included as part of a network(s) 1502. If present, the control system 1402 or the radio unit(s) are connected to the processing node(s) 1500 via the network 1502. Each processing node 1500 includes one or more processors 1504 (e.g., CPUs, ASICs, FPGAS, and/or the like), memory 1506, and a network interface 1508.

In this example, functions 1510 of the radio access node 1400 described herein (e.g., functions of the base station 102, 1102, or 1202) are implemented at the one or more processing nodes 1500 or distributed across the one or more processing nodes 1500 and the control system 1402 and/or the radio unit(s) 1410 in any desired manner. In some particular embodiments, some or all of the functions 1510 of the radio access node 1400 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1402 is used in order to carry out at least some of the desired functions 1510. Notably, in some embodiments, the control system 1402 may not be included, in which case the radio unit(s) 1410 communicate directly with the processing node(s) 1500 via an appropriate network interface(s).

In some embodiments, a computer program including instructions which, when executed by at least one processor, causes the at least one processor to carry out the functionality of radio access node 1400 or a node (e.g., a processing node 1500) implementing one or more of the functions 1510 of the radio access node 1400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the radio access node 1400 according to some other embodiments of the present disclosure. The radio access node 1400 includes one or more modules 1600, each of which is implemented in software. The module(s) 1600 provide the functionality of the radio access node 1400 described herein. This discussion is equally applicable to the processing node 1500 of FIG. 15 where the modules 1600 may be implemented at one of the processing nodes 1500 or distributed across multiple processing nodes 1500 and/or distributed across the processing node(s) 1500 and the control system 1402.

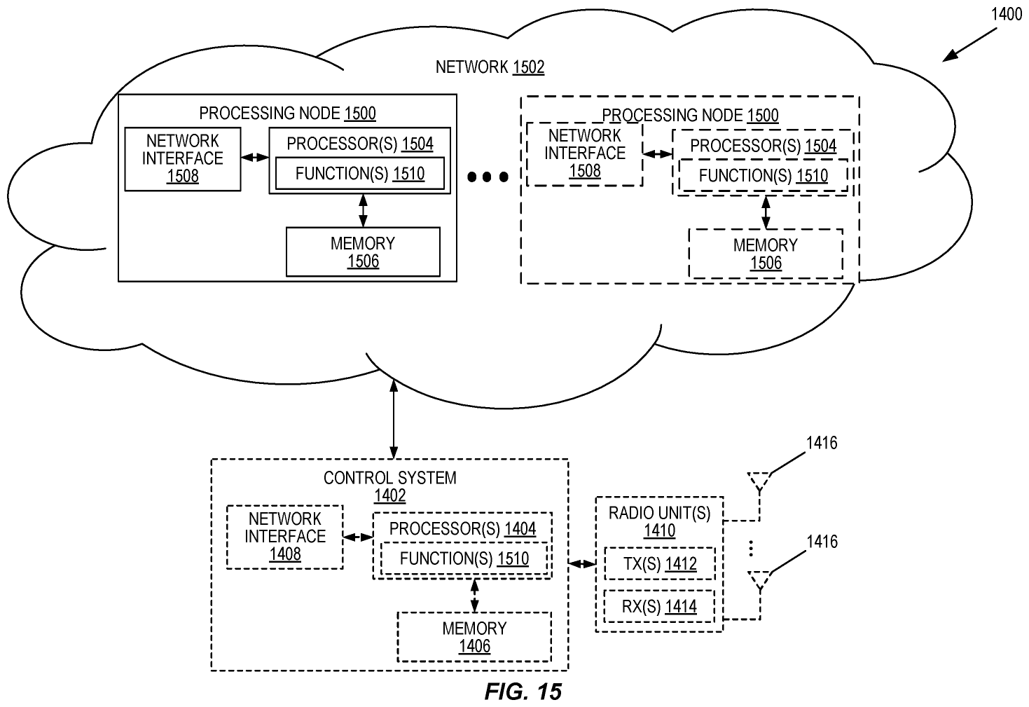

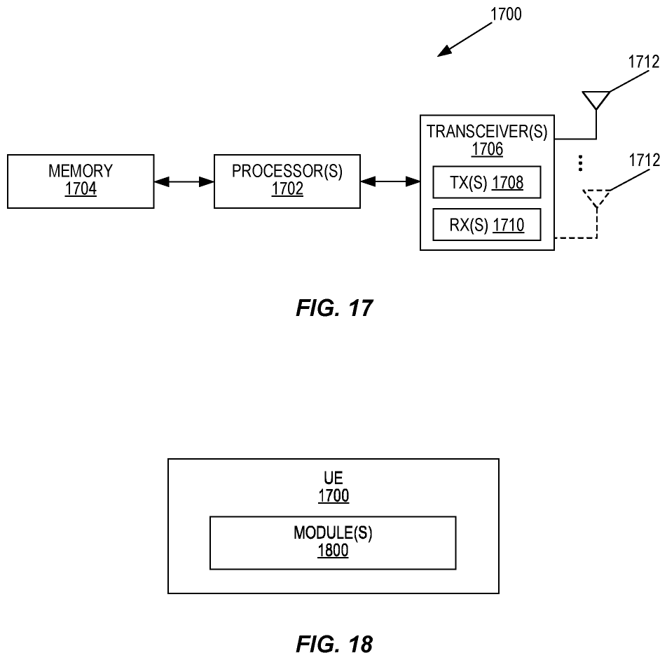

FIG. 17 is a schematic block diagram of a UE 1700 according to some embodiments of the present disclosure. The UE 1700 may be the relay UE 104, 604, 1104-1, 1104-2, 1204-1, or 1204-2 or the remote UE 106, 606, 1106-1, 1106-2, or 1206-3. As illustrated, the UE 1700 includes one or more processors 1702 (e.g., CPUs, ASICS, FPGAS, and/or the like), memory 1704, and one or more transceivers 1706 each including one or more transmitters 1708 and one or more receivers 1710 coupled to one or more antennas 1712. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1702 are also referred to herein as processing circuitry. The transceivers 1706 are also referred to herein as radio circuitry. In some embodiments, the functionality of the UE 1700 described above (e.g., the functionality of the relay UE 104, 604, 1104-1, 1104-2, 1204-1, or 1204-2 or the remote UE 106, 606, 1106-1, 1106-2, or 1206-3 described above) may be fully or partially implemented in software that is, e.g., stored in the memory 1704 and executed by the processor(s) 1702. Note that the UE 1700 may include additional components not illustrated in FIG. 17 such as, e.g., one or more user interface components (e.g., an input/output interface including a display, buttons, a touch screen, a microphone, a speaker(s), and/or the like and/or any other components for allowing input of information into the UE 1700 and/or allowing output of information from the UE 1700), a power supply (e.g., a battery and associated power circuitry), etc.

In some embodiments, a computer program including instructions which, when executed by at least one processor, causes the at least one processor to carry out the functionality of the UE 1700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the UE 1700 according to some other embodiments of the present disclosure. The UE 1700 includes one or more modules 1800, each of which is implemented in software. The module(s) 1800 provide the functionality of the UE 1700 described herein.

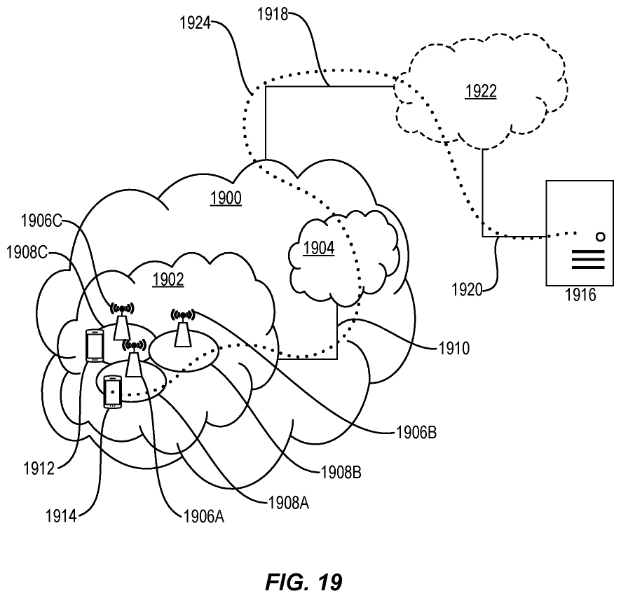

With reference to FIG. 19, in accordance with an embodiment, a communication system includes a telecommunication network 1900, such as a 3GPP-type cellular network, which comprises an access network 1902, such as a RAN, and a core network 1904. The access network 1902 comprises a plurality of base stations 1906A, 1906B, 1906C, such as Node Bs, eNBs, gNBs, or other types of wireless Access Points (APs), each defining a corresponding coverage area 1908A, 1908B, 1908C. Each base station 1906A, 1906B, 1906C is connectable to the core network 1904 over a wired or wireless connection 1910. A first UE 1912 located in coverage area 1908C is configured to wirelessly connect to, or be paged by, the corresponding base station 1906C. A second UE 1914 in coverage area 1908A is wirelessly connectable to the corresponding base station 1906A. While a plurality of UEs 1912, 1914 are illustrated in this example, the disclosed embodiments are equally applicable to a situation where a sole UE is in the coverage area or where a sole UE is connecting to the corresponding base station 1906.

The telecommunication network 1900 is itself connected to a host computer 1916, which may be embodied in the hardware and/or software of a standalone server, a cloud-implemented server, a distributed server, or as processing resources in a server farm. The host computer 1916 may be under the ownership or control of a service provider, or may be operated by the service provider or on behalf of the service provider. Connections 1918 and 1920 between the telecommunication network 1900 and the host computer 1916 may extend directly from the core network 1904 to the host computer 1916 or may go via an optional intermediate network 1922. The intermediate network 1922 may be one of, or a combination of more than one of, a public, private, or hosted network; the intermediate network 1922, if any, may be a backbone network or the Internet; in particular, the intermediate network 1922 may comprise two or more sub-networks (not shown).

The communication system of FIG. 19 as a whole enables connectivity between the connected UEs 1912, 1914 and the host computer 1916. The connectivity may be described as an Over-the-Top (OTT) connection 1924. The host computer 1916 and the connected UEs 1912, 1914 are configured to communicate data and/or signaling via the OTT connection 1924, using the access network 1902, the core network 1904, any intermediate network 1922, and possible further infrastructure (not shown) as intermediaries. The OTT connection 1924 may be transparent in the sense that the participating communication devices through which the OTT connection 1924 passes are unaware of routing of uplink and downlink communications. For example, the base station 1906 may not or need not be informed about the past routing of an incoming downlink communication with data originating from the host computer 1916 to be forwarded (e.g., handed over) to a connected UE 1912. Similarly, the base station 1906 need not be aware of the future routing of an outgoing uplink communication originating from the UE 1912 towards the host computer 1916.

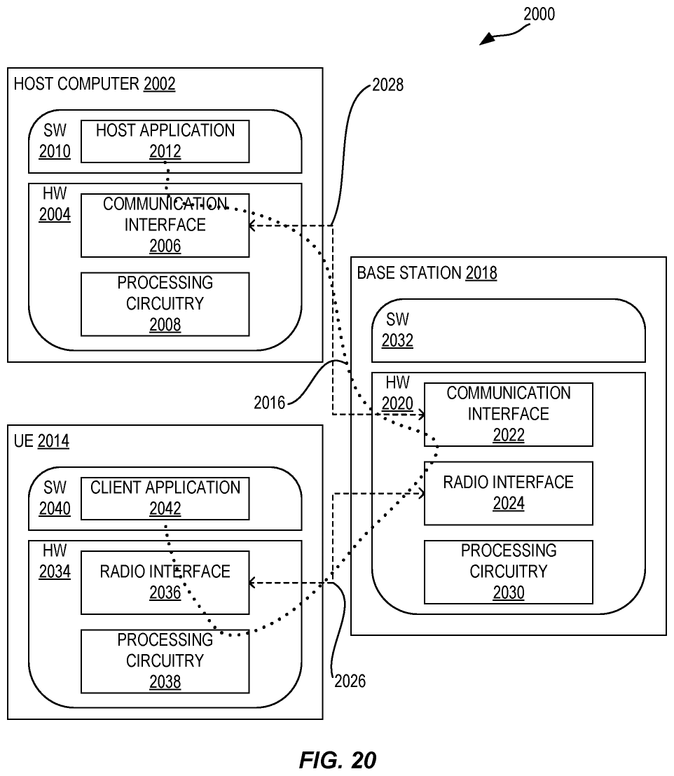

Example implementations, in accordance with an embodiment, of the UE, base station, and host computer discussed in the preceding paragraphs will now be described with reference to FIG. 20. In a communication system 2000, a host computer 2002 comprises hardware 2004 including a communication interface 2006 configured to set up and maintain a wired or wireless connection with an interface of a different communication device of the communication system 2000. The host computer 2002 further comprises processing circuitry 2008, which may have storage and/or processing capabilities. In particular, the processing circuitry 2008 may comprise one or more programmable processors, ASICs, FPGAs, or combinations of these (not shown) adapted to execute instructions. The host computer 2002 further comprises software 2010, which is stored in or accessible by the host computer 2002 and executable by the processing circuitry 2008. The software 2010 includes a host application 2012. The host application 2012 may be operable to provide a service to a remote user, such as a UE 2014 connecting via an OTT connection 2016 terminating at the UE 2014 and the host computer 2002. In providing the service to the remote user, the host application 2012 may provide user data which is transmitted using the OTT connection 2016.

The communication system 2000 further includes a base station 2018 provided in a telecommunication system and comprising hardware 2020 enabling it to communicate with the host computer 2002 and with the UE 2014. The hardware 2020 may include a communication interface 2022 for setting up and maintaining a wired or wireless connection with an interface of a different communication device of the communication system 2000, as well as a radio interface 2024 for setting up and maintaining at least a wireless connection 2026 with the UE 2014 located in a coverage area (not shown in FIG. 20) served by the base station 2018. The communication interface 2022 may be configured to facilitate a connection 2028 to the host computer 2002. The connection 2028 may be direct or it may pass through a core network (not shown in FIG. 20) of the telecommunication system and/or through one or more intermediate networks outside the telecommunication system. In the embodiment shown, the hardware 2020 of the base station 2018 further includes processing circuitry 2030, which may comprise one or more programmable processors, ASICs, FPGAs, or combinations of these (not shown) adapted to execute instructions. The base station 2018 further has software 2032 stored internally or accessible via an external connection.

The communication system 2000 further includes the UE 2014 already referred to. The UE's 2014 hardware 2034 may include a radio interface 2036 configured to set up and maintain a wireless connection 2026 with a base station serving a coverage area in which the UE 2014 is currently located. The hardware 2034 of the UE 2014 further includes processing circuitry 2038, which may comprise one or more programmable processors, ASICs, FPGAs, or combinations of these (not shown) adapted to execute instructions. The UE 2014 further comprises software 2040, which is stored in or accessible by the UE 2014 and executable by the processing circuitry 2038. The software 2040 includes a client application 2042. The client application 2042 may be operable to provide a service to a human or non-human user via the UE 2014, with the support of the host computer 2002. In the host computer 2002, the executing host application 2012 may communicate with the executing client application 2042 via the OTT connection 2016 terminating at the UE 2014 and the host computer 2002. In providing the service to the user, the client application 2042 may receive request data from the host application 2012 and provide user data in response to the request data. The OTT connection 2016 may transfer both the request data and the user data. The client application 2042 may interact with the user to generate the user data that it provides.

It is noted that the host computer 2002, the base station 2018, and the UE 2014 illustrated in FIG. 20 may be similar or identical to the host computer 1916, one of the base stations 1906A, 1906B, 1906C, and one of the UEs 1912, 1914 of FIG. 19, respectively. This is to say, the inner workings of these entities may be as shown in FIG. 20 and independently, the surrounding network topology may be that of FIG. 19.

In FIG. 20, the OTT connection 2016 has been drawn abstractly to illustrate the communication between the host computer 2002 and the UE 2014 via the base station 2018 without explicit reference to any intermediary devices and the precise routing of messages via these devices. The network infrastructure may determine the routing, which may be configured to hide from the UE 2014 or from the service provider operating the host computer 2002, or both. While the OTT connection 2016 is active, the network infrastructure may further take decisions by which it dynamically changes the routing (e.g., on the basis of load balancing consideration or reconfiguration of the network).

The wireless connection 2026 between the UE 2014 and the base station 2018 is in accordance with the teachings of the embodiments described throughout this disclosure. One or more of the various embodiments improve the performance of OTT services provided to the UE 2014 using the OTT connection 2016, in which the wireless connection 2026 forms the last segment.

A measurement procedure may be provided for the purpose of monitoring data rate, latency, and other factors on which the one or more embodiments improve. There may further be an optional network functionality for reconfiguring the OTT connection 2016 between the host computer 2002 and the UE 2014, in response to variations in the measurement results. The measurement procedure and/or the network functionality for reconfiguring the OTT connection 2016 may be implemented in the software 2010 and the hardware 2004 of the host computer 2002 or in the software 2040 and the hardware 2034 of the UE 2014, or both. In some embodiments, sensors (not shown) may be deployed in or in association with communication devices through which the OTT connection 2016 passes; the sensors may participate in the measurement procedure by supplying values of the monitored quantities exemplified above, or supplying values of other physical quantities from which the software 2010, 2040 may compute or estimate the monitored quantities. The reconfiguring of the OTT connection 2016 may include message format, retransmission settings, preferred routing, etc.; the reconfiguring need not affect the base station 2018, and it may be unknown or imperceptible to the base station 2018. Such procedures and functionalities may be known and practiced in the art. In certain embodiments, measurements may involve proprietary UE signaling facilitating the host computer's 2002 measurements of throughput, propagation times, latency, and the like. The measurements may be implemented in that the software 2010 and 2040 causes messages to be transmitted, in particular empty or ‘dummy’ messages, using the OTT connection 2016 while it monitors propagation times, errors, etc.

FIG. 21 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 21 will be included in this section. In step 2100, the host computer provides user data. In sub-step 2102 (which may be optional) of step 2100, the host computer provides the user data by executing a host application. In step 2104, the host computer initiates a transmission carrying the user data to the UE. In step 2106 (which may be optional), the base station transmits to the UE the user data which was carried in the transmission that the host computer initiated, in accordance with the teachings of the embodiments described throughout this disclosure. In step 2108 (which may also be optional), the UE executes a client application associated with the host application executed by the host computer.

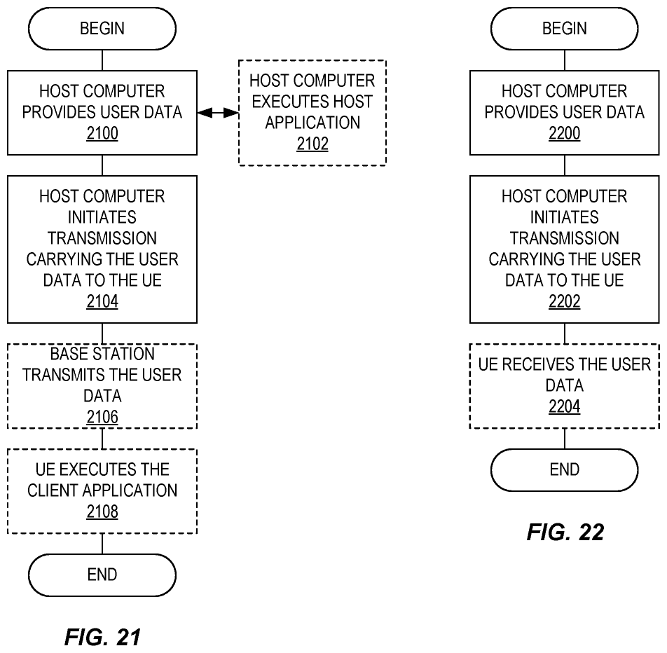

FIG. 22 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 22 will be included in this section. In step 2200 of the method, the host computer provides user data. In an optional sub-step (not shown) the host computer provides the user data by executing a host application. In step 2202, the host computer initiates a transmission carrying the user data to the UE. The transmission may pass via the base station, in accordance with the teachings of the embodiments described throughout this disclosure. In step 2204 (which may be optional), the UE receives the user data carried in the transmission.

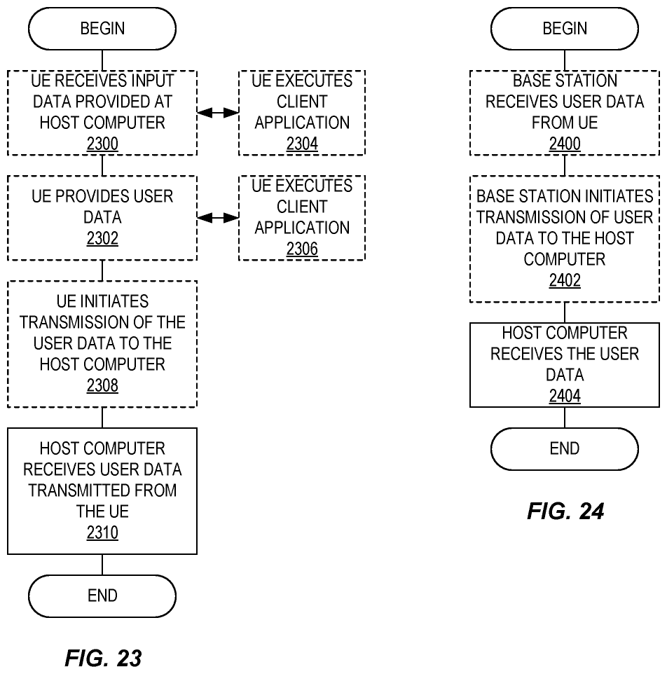

FIG. 23 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 23 will be included in this section. In step 2300 (which may be optional), the UE receives input data provided by the host computer. Additionally or alternatively, in step 2302, the UE provides user data. In sub-step 2304 (which may be optional) of step 2300, the UE provides the user data by executing a client application. In sub-step 2306 (which may be optional) of step 2302, the UE executes a client application which provides the user data in reaction to the received input data provided by the host computer. In providing the user data, the executed client application may further consider user input received from the user. Regardless of the specific manner in which the user data was provided, the UE initiates, in sub-step 2308 (which may be optional), transmission of the user data to the host computer. In step 2310 of the method, the host computer receives the user data transmitted from the UE, in accordance with the teachings of the embodiments described throughout this disclosure.

FIG. 24 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 24 will be included in this section. In step 2400 (which may be optional), in accordance with the teachings of the embodiments described throughout this disclosure, the base station receives user data from the UE. In step 2402 (which may be optional), the base station initiates transmission of the received user data to the host computer. In step 2404 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a relay User Equipment, UE, for group wake-up of a group of remote UEs, the method comprising:
receiving a group wake-up signal, WUS, from another radio node; and
performing a group wake-up procedure for a group of remote UEs that are in an idle state, the group of remote UEs comprising one or more remote UEs.

2. The method of claim 1 wherein performing the group wake-up procedure comprises:
detecting the group WUS received from the another radio node;
decoding the group WUS to determine the one or more remote UEs in the group of remote UEs; and
generating and transmitting a WUS to each of the one or more remote UEs in the group.

3. The method of claim 1 wherein performing the group wake-up procedure comprises:
monitoring for wake-up acknowledgements from the one or more remote UEs;
determining whether wake-up acknowledgements are detected from all of the one or more remote UEs while monitoring for the wake-up acknowledgements;
responsive to determining that wake-up acknowledgements have not been detected for all of the one or more remote UEs:
identifying one or more remote UEs in the group for which a wake-up acknowledgement has not been detected; and
transmitting a wake-up signal to the one or more remote UEs in the group for which a wake-up acknowledgement has not been detected.

4. The method of claim 3 wherein:
performing the group wake-up procedure further comprises setting one or more timers; and
monitoring for wake-up acknowledgements from the one or more remote UEs comprises monitoring for wake-up acknowledgements from the one or more remote UEs while the one or more timers are running.

5. (canceled)

6. The method of claim 1 wherein performing the group wake-up procedure for the group of remote UEs comprises transmitting a low-power wake-up signal, LPWUS, to each of at least a subset of remote UEs in the group.

7. The method of claim 6 wherein the LPWUS has one or more characteristics that enable a power cost for detecting the LPWUS to be less than a power cost for detecting a wake-up signal, WUS, from a base station.

8. The method of claim 6 further comprising generating and transmitting a synchronization signal for the at least a subset of remote UEs in the group.

9. The method of claim 8 wherein generating and transmitting the synchronization signal for the at least a subset of remote UEs in the group comprises either:
broadcasting the synchronization signal for the at least a subset of remote UEs in the group; or
generating and transmitting a separate synchronization signal to each UE in the subset of remote UEs in the group.

10. (canceled)

11. The method of claim 1 wherein performing the group wake-up procedure comprises:
detecting the group WUS received from the another radio node;
decoding the group WUS to determine the one or more remote UEs in the group of remote UEs;
monitoring for wake-up acknowledgements from the one or more remote UEs;
determining whether wake-up acknowledgements are detected from all of the one or more remote UEs while monitoring for the wake-up acknowledgements;
responsive to determining that wake-up acknowledgements have not been detected for all of the one or more remote UEs:
identifying one or more remote UEs in the group for which a wake-up acknowledgement has not been detected; and
transmitting a wake-up signal to the one or more remote UEs in the group for which a wake-up acknowledgement has not been detected.

12. The method of claim 11 wherein:
performing the group wake-up procedure further comprises setting one or more timers; and
wherein monitoring for wake-up acknowledgements from the one or more remote UEs comprises monitoring for wake-up acknowledgements from the one or more remote UEs while the one or more timers are running.

13. The method of claim 11 wherein transmitting the wake-up signal to the one or more remote UEs in the group for which a wake-up acknowledgement has not been detected comprises transmitting a low-power wake-up signal, LPWUS, to each of the one or more remote UEs in the group for which a wake-up acknowledgement has not been detected.

14. The method of claim 13 wherein the LPWUS has one or more characteristics that enable a power cost for detecting the LPWUS to be less than a power cost for detecting a wake-up signal, WUS, from a base station.

15. The method of claim 11 further comprising transmitting a synchronization signal for the one or more remote UEs in the group for which a wake-up acknowledgement has not been detected.

16. The method of claim 15 wherein transmitting the synchronization signal for the one or more remote UEs in the group for which a wake-up acknowledgement has not been detected comprises either:
broadcasting the synchronization signal for the one or more remote UEs in the group for which a wake-up acknowledgement has not been detected; or
transmitting a separate synchronization signal to each of the one or more remote UEs in the group for which a wake-up acknowledgement has not been detected.

17. (canceled)

18. The method of claim 1 further comprising repeating the group wake-up procedure until either wake-up acknowledgements have been detected for all of the one or more remote UEs in the group or a predefined or preconfigured maximum number of wake-up attempts has been reached.

19-24. (canceled)

25. A relay User Equipment, UE, for group wake-up of a group of remote UEs, the relay UE comprising:
one or more transmitters;
one or more receivers; and
processing circuitry associated with the one or more transmitters and the one or more receivers, the processing circuitry configured to cause the relay UE to:
receive a group wake-up signal, WUS, from another radio node; and
perform a group wake-up procedure for a group of remote UEs that are in an idle state, the group of remote UEs comprising one or more remote UEs.

26. (canceled)

27. A method performed by a remote User Equipment, UE, for wake-up from an idle state, the method comprising:
receiving a wake-up signal, WUS, from a first relay UE for group wake-up of a first group of remote UEs in which the remote UE is included; and
refraining from responding to a WUS from any other relay UE for group wake-up of another group of remote UEs in which the remote UE is also included while performing wake-up responsive to receiving the WUS from the first relay UE.

28. The method of claim 27 further comprising, after wake-up:
receiving a WUS from a second relay UE for group wake-up of a second group of remote UEs in which the remote UE is included; and
responding to the second relay UE.

29. The method of claim 28 wherein responding to the second relay UE comprises either:
sending a negative acknowledgement to the second relay UE; or
sending a positive acknowledgement to the second relay UE.

30-32. (canceled)

33. A remote User Equipment, UE, for wake-up from an idle state, the remote UE comprising:
one or more transmitters;
one or more receivers; and
processing circuitry associated with the one or more transmitters and the one or more receivers, the processing circuitry configured to cause the remote UE to:
receive a wake-up signal, WUS, from a first relay UE for group wake-up of a first group of remote UEs in which the remote UE is included;
refrain from responding to a WUS from any other relay UE for group wake-up of another group of remote UEs in which the remote UE is also included while performing wake-up responsive to receiving the WUS from the first relay UE.

34. (canceled)
